(19) United States
(12) Patent Application Publication
(10) Pub. No.: US 2015/0081422 A1
(43) Pub. Date: Mar. 19, 2015

(54) SERVICE PROVIDING APPARATUS AND SERVICE PROVIDING METHOD

(71) Applicant: YAHOO JAPAN CORPORATION, Tokyo (JP)

(72) Inventors: Toru TAKATA, Tokyo (JP); Nobuyuki AKASHI, Tokyo (JP); Akira TAJIMA, Tokyo (JP); Koji TSUKAMOTO, Tokyo (JP); Nari WOO, Tokyo (JP); Akihiro TANABE, Tokyo (JP); Shinichiro SEGA, Tokyo (JP)

(21) Appl. No.: 14/332,936

(22) Filed: Jul. 16, 2014

(30) Foreign Application Priority Data
Sep. 19, 2013 (JP) 2013-194670

(51) Int. Cl. G06Q 30/02

(52) U.S. Cl. CPC G06Q 30/0275; G06Q 30/0246
USPC 705/14.45; 705/14.71

(57) ABSTRACT

A service providing apparatus includes a plan receiving unit, a calculating unit, and a service providing unit. The plan receiving unit receives plan information indicating a plan of content planned by a content creator. The calculating unit calculates the number of predicted views that is a predicted value of the number of times at which the content is viewed by a user. The service providing unit presents the number of predicted views calculated by the calculating unit and the plan information received by the plan receiving unit, and provides an auction service in which a bid target is a right to display an advertisement on the content.

### CROSS-REFERENCE TO RELATED APPLICATIONS

The present application claims priority to and incorporates by reference the entire contents of Japanese Patent Application No. 2013-194670 filed in Japan on Sep. 19, 2013.

### BACKGROUND OF THE INVENTION

1. Field of the Invention

The present invention relates to a service providing apparatus and a service providing method.

2. Description of the Related Art

A distribution service has been known which distributes various kinds of content to a terminal apparatus of the user through the Internet. As an example of the distribution service, a moving image distribution service has been known which distributes moving image content and advertising content which is displayed in a display area of the moving image content.

In regard to the moving image distribution service, a technique called a program auction has been proposed. Specifically, in the program auction, sponsors bid for a given amount of investment money and only the sponsor who bids against the other sponsors has a broadcast right to a CM space for broadcasting hours. This program auction is used to make a definite promise to ensure funds beforehand.

However, in the related art, it is not always possible to provide value-added services for advertisers. Specifically, in the known art described above, advertisers simply compete for the broadcast rights for the CM space in the auction. For this reason, it is difficult to provide value-added services to the advertisers attending the auction.

### SUMMARY OF THE INVENTION

It is an object of the present invention to at least partially solve the problems in the conventional technology.

According to one aspect of an embodiment, a service providing apparatus includes a plan receiving unit configured to receive plan information indicating a plan of content planned by a content creator; a calculating unit configured to calculate the number of predicted views that is a predicted value of the number of times at which the content is viewed by a user; and a providing unit configured to present the number of predicted views calculated by the calculating unit and the plan information received by the plan receiving unit, and provides an auction service in which a bid target is a right to display an advertisement on the content.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of the service providing process according to an embodiment;

FIG. 2 is a diagram illustrating an exemplary structure of a service providing system according to the embodiment;

FIG. 3 is a diagram illustrating an exemplary structure of a service providing apparatus according to the embodiment;

FIG. 4 is a diagram illustrating an exemplary auction storage unit according to the embodiment;

FIG. 5 is a diagram illustrating an exemplary history information storage unit according to the embodiment;

FIG. 6 is a diagram illustrating an exemplary list page according to the embodiment;

FIG. 7 is a diagram illustrating an exemplary auction page according to the embodiment;

FIG. 8 is a sequence diagram illustrating a service providing process by a service providing system according to the embodiment;

FIG. 9 is a diagram illustrating an exemplary service providing process according to a modified example;

FIG. 10 is a diagram illustrating an exemplary auction storage unit according to the modified example;

FIG. 11 is a diagram illustrating an exemplary auction page according to the modified example;

FIG. 12 is a diagram illustrating an exemplary accounting process according to the modified example;

FIG. 13 is a diagram illustrating an exemplary auction page according to the modified example;

FIG. 14 is a diagram illustrating exemplary content according to the modified example; and

FIG. 15 is a hardware block diagram illustrating an exemplary of a computer to realize the function of the service providing apparatus.

### DETAILED DESCRIPTION OF THE PREFERRED EMBODIMENTS

Hereinafter, a service providing apparatus, a service providing method, and a service providing program according to exemplary embodiment (hereinafter, referred to as an “embodiment”) will be described in detail with reference to the accompanying drawings. In addition, the service providing apparatus, the service providing method, and the service providing program are not limited by the embodiment. In the following embodiments, the same components are denoted by the same reference numerals and the description thereof will not be repeated.

### 1. Service Providing Process

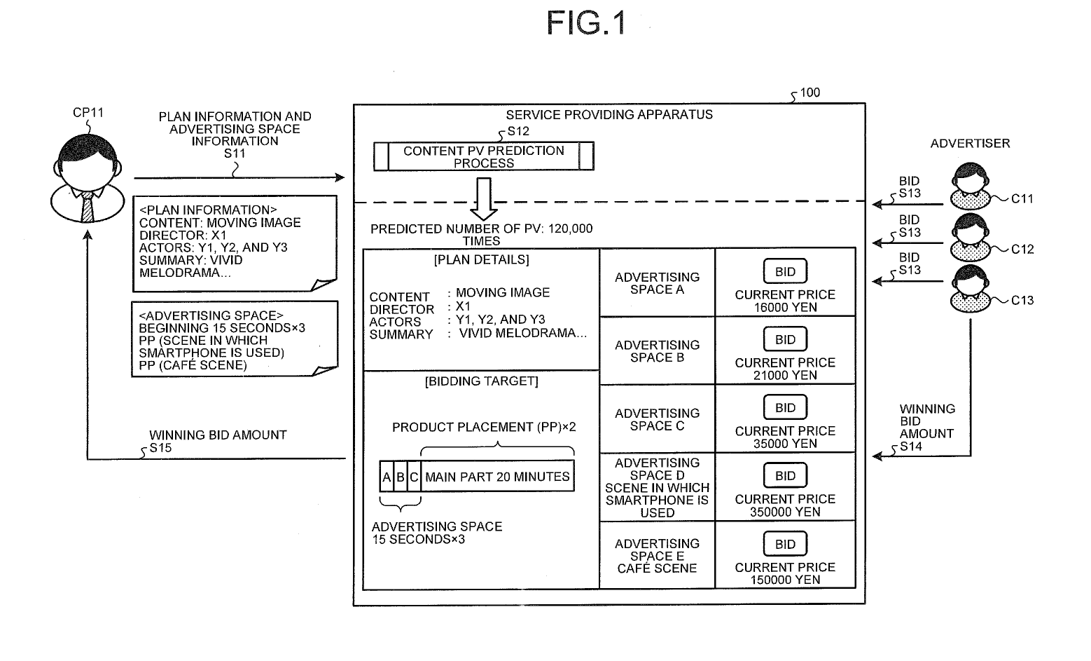

First, an example of the service providing process according to an embodiment will be described with reference to FIG. 1. FIG. 1 is a diagram illustrating an example of the service providing process according to the embodiment. A service providing apparatus 100 illustrated in FIG. 1 predicts the number of times at which content is delivered, when plan information of the content is received from a content creator. Then, the service providing apparatus 100 presents the predicted the number of times of distribution, and then provides an auction service in which a bid target, that is an item to be auctioned off, is right to display an advertisement on the content. Hereinafter, a moving image is given as an example of content. In the following description, in some cases, the number of times of distribution is referred to as a “number of deliveries”.

As illustrated in FIG. 1, the service providing apparatus 100 receives plan information indicating a plan of a moving image and advertising space information relating to an advertising space which is set to the moving image by a content creator CP11, from the content creator CP11 who plans to create the moving image (step S11). In the following description, in some cases, the plan of content (for example, the moving image) is referred to as a “content-plan”. In addition, the service providing apparatus 100 may receive the plan information and the advertising space information at the same time or at different times.

In the example illustrated in FIG. 1, the plan information transmitted by the content creator CP11 includes information indicating that the type of content is a moving image, the director of the moving image is “X1”, the actors of the moving image are “Y1”, “Y2” and “Y3”, and the summary of the moving image is “vivid melodrama”. In addition, the advertising space information transmitted by the content creator CP11 includes information relating to three advertising spaces which are set to the beginning of the moving image, an advertising space which is set to a scene in which a smart phone is used among various kinds of scenes included in the moving image, and an advertising space which is set to a café scene. Here, the advertising space set to the scene in which a smart phone is used or the advertising space set to the scene of the café indicates a cast frame to make a product that an advertiser desires to advertise appear in the moving image. For example, an advertiser who has made a successful bid for the advertising space, which is set for the scene in which a smart phone is used, can make cast members appearing in the moving image use the smart phone to be advertised. Such a method of displaying an advertisement in the main part of the moving image so as to be associated with a specific scene or a cast member is called product placement or the like.

Subsequently, after receiving the plan information from the content creator CP11, the service providing apparatus 100 predicts the number of deliveries of a moving image that is content being planned (step S12). A process of predicting the number of deliveries will be described later, but the service providing apparatus 100 predicts the number of deliveries based on, for example, the plan information, a delivery history of a moving image having created previously, or the like. Note that the number of deliveries indicates, in other words, the number of times at which a moving image is viewed by the user. Hereinafter, the number of deliveries is described in some cases as “the number of PV (page view)” indicating the number of times at which content is viewed by the user. Furthermore, hereinafter, a predicted value of the number of PV may be described in some cases as “the predicted number of PV”.

Then, the service providing apparatus 100 presents the advertiser the predicted number of PV, and provides an auction service in which the right to display an advertisement on an advertising space to be set to the moving image is a bid target. That is, at a stage in which the content creator CP11 plans to create the moving image, the service providing apparatus 100 presents the predicted number of PV in content being planned, and holds an auction in which the bid target is the right to incorporate an advertisement into the moving image.

In the case of the example of FIG. 1, the service providing apparatus 100 presents the advertiser “120,000” as the predicted number of PV of content being planned by the content creator CP11. Furthermore, the service providing apparatus 100 opens the type, director, actor, and summary of content on the basis of the plan information, and individually provides an auction service related to each advertising space on the basis of the advertising space information. Specifically, the service providing apparatus 100 individually holds auctions for the advertising spaces A, B and C displayed in the beginning of the moving image and the advertising spaces D and E displayed in the main part of a moving image.

Subsequently, the service providing apparatus 100 receives bids from the advertisers in each auction (step S13). Then, the service providing apparatus 100 determines the advertiser who bids the highest price to be a winning bidder for the period for which the auction is being held and receives the winning bid amount from the winning bidder (step S14). Then, the service providing apparatus 100 sends the winning bid amount received from the winning bidder to the content creator CP11 (step S15). Although subsequent processes will be described in detail later, the service providing apparatus 100 generates a moving image to be distributed by incorporating advertisement data received from the winning bidder into the moving image created by the content creator CP11 after all auctions for respective advertising spaces are successful. In addition, although the advertisement of a different advertiser is displayed on a general web page for each access to the web page, only advertisement data corresponding to the winning bidder is incorporated into each advertising space set for the content such as a moving image according to the embodiment. That is, an advertiser who has become the winning bidder will monopolize the advertising space in which an advertisement is displayed.

As described above, at the stage in which the content creator is planning to create a moving image, the service providing apparatus 100 according to the embodiment presents a predicted number of PV of the moving image, and holds an auction. Thus, the service providing apparatus 100 enables the advertiser that is a bidder to apprehend the number of times at which an advertisement is likely to be viewed by the user. Specifically, in the auction service provided by the service providing apparatus 100, a right to display an advertisement in a moving image at the planning stage is a bid target. For this reason, the advertiser that is a bidder cannot check a finished product of a moving image at the time of bidding, and thus it is difficult to predict the number of times at which a finished product of a moving image is delivered. However, the service providing apparatus 100 according to the embodiment provides the auction service while presenting the predicted number of PV, and thus, even when an auction is held at the stage of planning a moving image, can provide information serving as a reference at the time of bidding to the advertiser. As a result, the service providing apparatus 100 can provide a service having an value-added to the advertiser.

### 2. Structure of Service Providing System

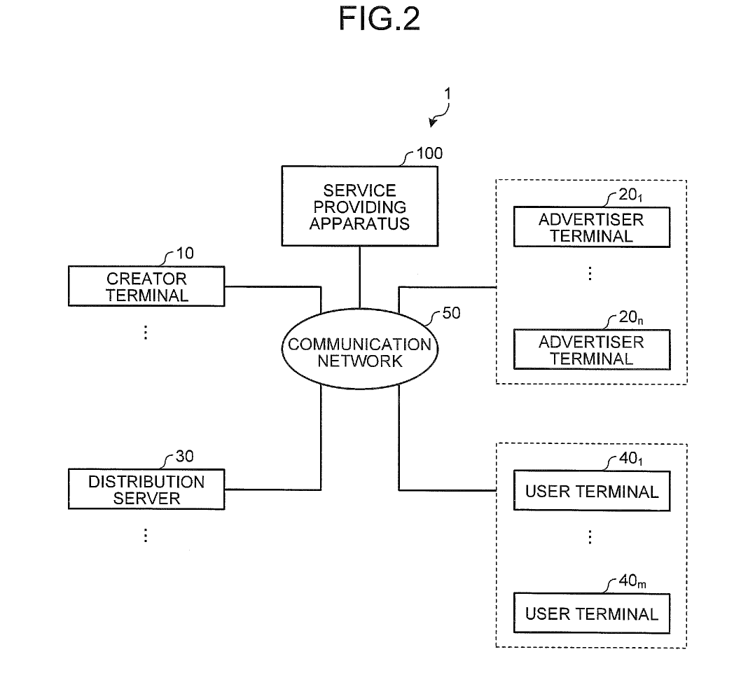

Next, the structure of the service providing system according to the embodiment will be described with reference to FIG. 2. FIG. 2 is a diagram illustrating an example of the structure of the service providing system according to the embodiment. As illustrated in FIG. 2, a service providing system 1 includes a creator terminal 10, advertiser terminals 20₁ to 20ₙ, a distribution server 30, user terminals 40₁ to 40ₘ, and the service providing apparatus 100. The creator terminal 10, the advertiser terminals 20₁ to 20ₙ, the distribution server 30, the user terminals 40₁ to 40ₘ, and the service providing apparatus 100 are connected through a communication network 50 so as to communicate with each other wirelessly or by wire. In addition, the service providing system 1 illustrated in FIG. 2 may include a plurality of creator terminals 10, a plurality of distribution servers 30, a plurality of service providing apparatuses 100.

The creator terminal 10 is an information processing apparatus which is used by the content creator. For example, the creator terminal 10 is operated by the content creator to transmit the plan information, the advertising space information, or content, such as a moving image created by the content creator, to the service providing apparatus 100. In the following description, in some cases, the creator terminal 10 is referred to as a content creator. That is, in the following description, the content creator may be replaced with the creator terminal 10.

In some cases, the content creator requests an agent to transmit the plan information. In this case, the agent uses the auction service provided by the service providing apparatus 100. Hereinafter, it is assumed that the term “content creator” includes the agent in addition to the content creator and the term “creator terminal” includes an agent terminal used by the agent in addition to the advertiser terminal.

The advertiser terminals 20₁ to 20ₙ are information processing apparatuses used by advertisers. For example, the advertiser terminals 20₁ to 20ₙ are operated by the advertisers to acquire a web page (hereinafter, may be written as an “auction page”) related to the auction service from the service providing apparatus 100 or to transmit bid information or advertisement data to the service providing apparatus 100. In the following description, in some cases, when it is not necessary to distinguish the advertiser terminals 20₁ to 20ₙ, the advertiser terminals 20₁ to 20ₙ are generically referred to as an “advertiser terminal 20”. In addition, in the following description, in some cases, the advertiser terminal 20 is referred to as an advertiser, a bidder, or a winning bidder. That is, in the following description, the advertiser, the bidder, or the winning bidder may be replaced with the advertiser terminal 20.

In some cases, the advertiser requests the agent to perform a bid operation. In this case, the agent uses the auction service provided by the service providing apparatus 100. In the following description, it is assumed that the term “advertiser” includes the agent in addition to the advertiser and the term “advertiser terminal” includes the agent terminal used by the agent in addition to the advertiser terminal.

The distribution server 30 is, for example, a web server or the like. The distribution server 30 receives distribution target content from the service providing apparatus 100. In addition, the distribution server 30 distributes the content received from the service providing apparatus 100 in response to the requests from the user terminals 40₁ to 40ₘ.

The user terminals 40₁ to 40ₘ are information processing apparatuses used by users who view content. For example, the user terminals 40₁ to 40ₘ are operated by the users to acquire content, such as a moving image, from the distribution server 30 and to display the acquired content on a display device (for example, liquid crystal display). In the following description, when it is not necessary to distinguish the user terminals 40₁ to 40ₘ, the user terminals 40₁ to 40ₘ are generically referred to as a “user terminal 40”. In the following description, in some cases, the user terminal 40 is referred to as a user or a viewer. That is, in the following description, the user or the viewer may be replaced with the user terminal 40.

The service providing apparatus 100 is, for example, a web server or the like. As described with reference to FIG. 1, the service providing apparatus 100 provides the auction service related to the advertising space which is incorporated into content in the planning stage.

The creator terminal 10, the advertiser terminal 20, or the user terminal 40 is implemented by, for example, a desktop personal computer (PC), a notebook PC, a tablet terminal, a mobile phone, or a personal digital assistant (PDA).

### 3. Structure of Service Providing Apparatus

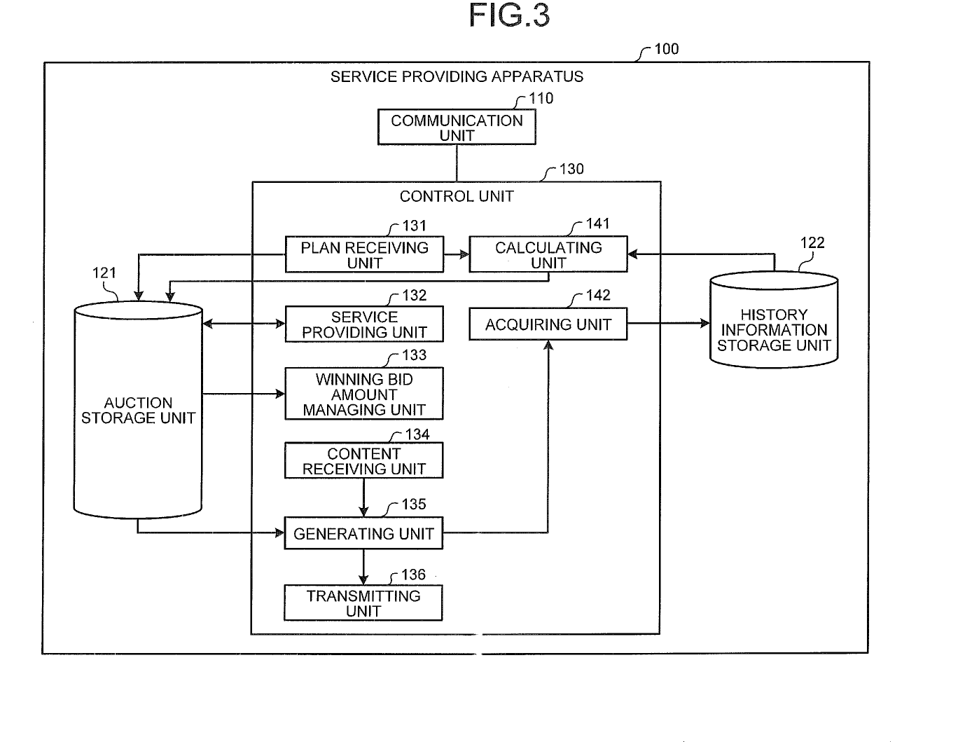

Next, the structure of the service providing apparatus 100 according to the embodiment will be described with reference to FIG. 3. FIG. 3 is a diagram illustrating an example of the structure of the service providing apparatus 100 according to the embodiment. As illustrated in FIG. 3, the service providing apparatus 100 includes a communication unit 110, an auction storage unit 121, a history information storage unit 122, and a control unit 130. In addition, the service providing apparatus 100 may include an input unit (for example, a keyboard, a mouse, and the like) which receives various types of operations from an administrator of the service providing apparatus 100 or the like or a display unit (for example, a liquid crystal display or the like) which displays various kinds of information.

The communication unit 110 is implemented by, for example, a network interface card (NIC). The communication unit 110 is connected with the communication network 50 in a wired or wireless manner. Then, the communication unit 110 transmits and receives information to and from the creator terminal 10, the advertiser terminal 20, or the distribution server 30 via the communication network 50.

The auction storage unit 121 and the history information storage unit 122 are implemented by a semiconductor memory element, such as a random access memory (RAM) or a flash memory, or a storage device, such as a hard disk or an optical disk.

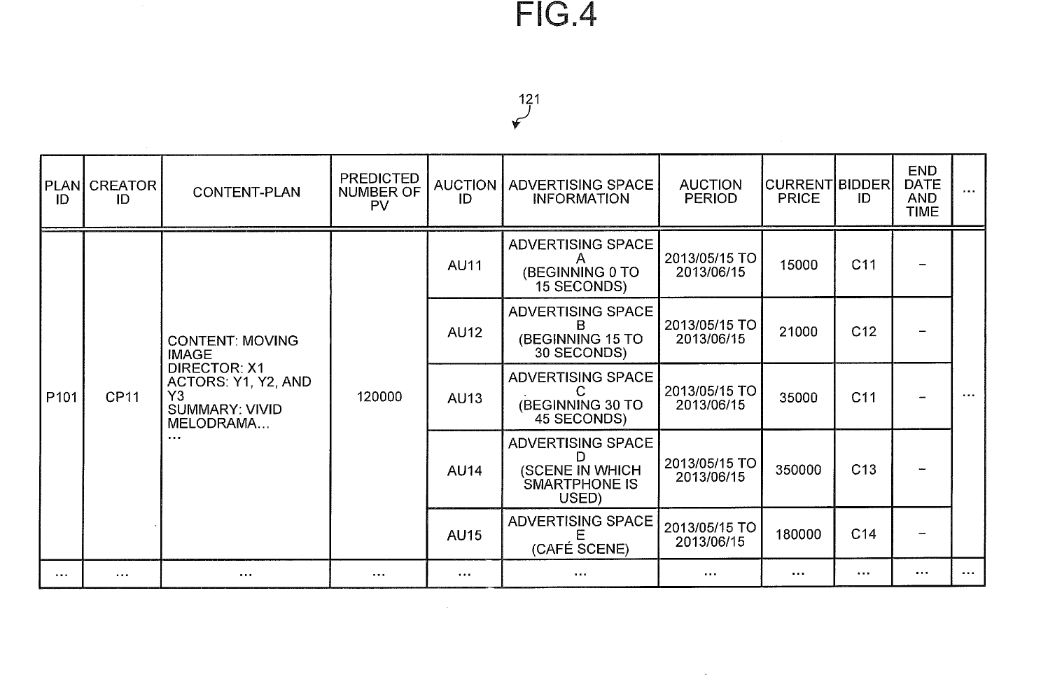

The auction storage unit 121 stores various kinds of information regarding an auction. FIG. 4 illustrates an example of the auction storage unit 121 according to the embodiment. As illustrated in FIG. 4, the auction storage unit 121 includes items such as “plan ID”, “creator ID”, “content-plan”, “predicted number of PV”, “auction ID”, “advertising space information”, “auction period”, “current price”, “bidder ID”, and “end date and time”.

The “plan ID” indicates identification information for identifying content which is planned to be created by the content creator. The “creator ID” indicates identification information for identifying the content creator. The “content-plan” indicates, for example, skeleton, details or the like of the content. The “predicted number of PV” indicates a predicted value of the number of times at which a finished product of content that is planned to be created by the content creator is viewed by the user. The “predicted number of PV” is calculated by a calculating unit 141 which will be described later. The “auction ID” indicates identification information for identifying the auction related to each advertising space. In other words, the “auction ID” indicates identification information for identifying an advertising space. The “advertising space information” indicates information related to the advertising space incorporated into the content. The “auction period” indicates the period for which the auction is held. The “current price” indicates the highest price of bid prices offered for the auction at the moment. The “bidder ID” indicates an advertiser ID for identifying an advertiser who is a bidder who has bid a highest price at the moment. The “end date and time” indicates date and time when the auction has ended.

Note that in FIG. 4, an auction for which the date and time is not stored in the “end date and time” indicates an auction that is being held or has not been held, and an auction for which the date and time is stored in the “end date and time” indicates an auction that has ended. Furthermore, when the date and time is stored in the “end date and time”, the current price corresponds to the winning bid price, and the bidder corresponds to a winning bidder. Furthermore, in the example of FIG. 4, the “creator ID” is assumed to correspond to a reference numeral given to the content creator illustrated in FIG. 1. For example, a creator ID “CP11” indicates the content creator CP11. Furthermore, hereinafter, information stored in the “bidder ID” illustrated in FIG. 4 is used in some cases as a reference numeral of an advertiser. For example, the advertiser identified by a bidder ID “C11” is described in some cases as an “advertiser C11”.

That is, FIG. 4 illustrates an example in which the content creator CP11 is planning content identified by a plan ID “P101”, and content-plan is a moving image or the like. Furthermore, FIG. 4 illustrates an example in which the predicted number of times at which the content being planned will be viewed by a user is 120,000 times. Furthermore, FIG. 4 illustrates an example in which the five advertising spaces A to E are incorporated into the content. Furthermore, FIG. 4 illustrates an example in which an auction related to the advertising space A is identified by an auction ID “AU11”, and similarly, auctions related to the advertising spaces B to E are identified by auction IDs “AU12”, “AU13”, “AU14”, and “AU15”, respectively. Furthermore, FIG. 4 illustrates an example in which the auctions related to the advertising spaces A to E are being held or is not held yet. As described above, the auction storage unit 121 stores an auction ID corresponding to each advertising space incorporated into content in association with one plan ID (that is, content at the planning stage).

Note that information stored in the auction storage unit 121 is not limited to the example illustrated in FIG. 4. For example, the auction storage unit 121 may store a “buyout price” indicating a price at which a successful bid for a bid target can be immediately made, a “lowest winning bid price” indicating a minimum price at which a successful bid for a bid target can be made, or the like for each auction ID. For example, the “buyout price” and the “lowest winning bid price (reserve price)” are included in the advertising space information to be transmitted from the creator terminal 10 to the service providing apparatus 100 and set by the content creator.

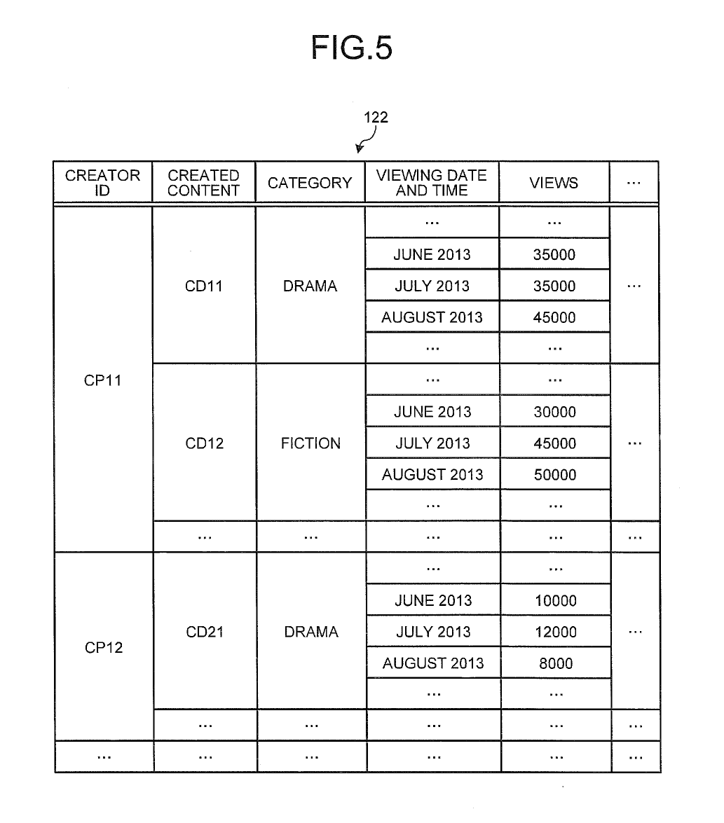

The history information storage unit 122 stores various kinds of information related to content having created previously by the content creator. FIG. 5 illustrates an example of the history information storage unit 122 according to the embodiment. As illustrated in FIG. 5, the history information storage unit 122 includes items such as “creator ID”, “created content”, “category”, “viewing date and time”, and the “views”.

The “creator ID” corresponds to the creator ID illustrated in FIG. 4. The “created content” indicates content created in the past by the content creator. FIG. 5 illustrates an example in which conceptual information such as “CD11” is stored in the “created content”, but practically, content such as a moving image, a file path name indicating a storage location of content, or the like is stored.

The “category” indicates the category to which the created content belongs. Examples of the category of the created content include a drama, a fiction, and an animation. Note that for example, a content category is included in the plan information, and set to the content creator. However, a content category may be set by an administrator of the service providing apparatus 100 or the distribution server 30 that has checked finished content. The “viewing date and time” indicates a date and time on which content was viewed. In other word, the “viewing date and time” indicates a date and time on which content was browsed. In the example of FIG. 5, information indicating a year and a month among a year, a month, a date, a time, a minute, and a second is stored in the “viewing date and time”. The “views” indicates the number of times at which content has been viewed. In other words, the “views” indicates the number of times at which content (actually, composite content which will be described later) has been delivered to the user terminal 40 by the distribution server 30. FIG. 5 illustrates an example in which the monthly views is stored in the “views”.

That is, FIG. 5 illustrates an example in which content “CD11” and content “CD12” have been created previously by the content creator CP11. Furthermore, FIG. 5 illustrates an example in which the content “CD11” is content (for example, a moving image) related to a drama. Furthermore, FIG. 5 illustrates an example in which the content “CD11” was viewed 35,000 times on June 2013, viewed 35,000 times on July 2013, and viewed 45,000 times on August 2013.

Note that the history information storage unit 122 may not store a viewing date and time. Specifically, the history information storage unit 122 may store only a total of the numbers of views up to the present point in time since delivery of created content started.

Referring back to FIG. 3, for example, the control unit 130 is implemented such that a central processing unit (CPU), a micro processing unit (MPU), or the like executes various kinds of programs (corresponding to an exemplary service providing program) stored in an internal storage device of the service providing apparatus 100 using a RAM as a working area. Furthermore, for example, the control unit 130 is implemented by an integrated circuit such as an application specific integrated circuit (ASIC) and a field programmable gate array (FPGA).

As illustrated in FIG. 3, the control unit 130 includes a plan receiving unit 131, a service providing unit 132, a winning bid amount managing unit 133, a content receiving unit 134, a generating unit 135, a transmitting unit 136, the calculating unit 141, and an acquiring unit 142, and implements or executes a function or an operation of information processing which will be described below. Note that an internal configuration of the control unit 130 is not limited to the configuration illustrated in FIG. 3, and may have other configuration as long as it is a configuration of performing information processing which will be described later. Furthermore, a connection relation of the respective processing units of the control unit 130 is not limited to the connection relation illustrated in FIG. 3 and may be other connection relation.

The plan receiving unit 131 receives the plan information and the advertising space information from the content creator (for example, the creator terminal 10) who plans to create content. Specifically, the plan receiving unit 131 receives the plan information indicating content-plan and the advertising space information related to an advertising space to be set to content by the content creator from the content creator. Then, when the plan information and the advertising space information is received, the plan receiving unit 131 allocates a new plan ID, and allocates an auction ID for each advertising space to be set to content. Then, the plan receiving unit 131 stores the plan information in the “content-plan” of the auction storage unit 121 in association with the plan ID. Furthermore, the plan receiving unit 131 stores the auction ID for each advertising space in the auction storage unit 121 in association with the plan ID, and further stores the advertising space information in the “advertising space information” of the auction storage unit 121 in association with each auction ID. At this time, the plan receiving unit 131 stores the creator ID corresponding to the content creator that is a transmission source of the plan information and the advertising space information, in the auction storage unit 121 as well. For example, the creator ID is transmitted by the content creator together with the plan information and the advertising space information. Alternatively, when a login process is necessary in using various kinds of services provided by the service providing apparatus 100, a login ID of the content creator or the like may be used as the creator ID.

Note that for example, the plan receiving unit 131 analyzes the plan information, and thus extracts information corresponding to each item such as the type, the director, and the actor of the content. For example, when the plan information is described in a markup language such as XML (Extensible Markup Language), the plan receiving unit 131 can easily extract information corresponding to each item from the plan information. Furthermore, when the plan information has a predefined format, the plan receiving unit 131 can easily extract various kinds of information from the plan information based on the predefined format. Similarly, when the advertising space information is described in a markup language or when the advertising space information has a predefined format, the plan receiving unit 131 can easily extract various kinds of information from the advertising space information.

Furthermore, the plan receiving unit 131 may receive the advertising space information including the auction period set by the content creator. In this case, the plan receiving unit 131 stores the auction period included in the advertising space information in the auction storage unit 121. However, the plan receiving unit 131 is not limited to this example, and may store a predefined auction period in the auction storage unit 121. For example, the plan receiving unit 131 may use a period of time until a predetermined number of days elapses from a date and time on which the advertising space information was received, as the auction period.

Furthermore, the plan receiving unit 131 may provide a submission site for inputting the plan information and the advertising space information to the content creator. For example, the plan receiving unit 131 provides a submission site for inputting a type of content, content-plan, and the like. Furthermore, for example, the plan receiving unit 131 provides a submission site for inputting a temporal position where an advertising space is reproduced (hereinafter, may be written as a reproduction position), reproduction time of the advertising space, display size of the advertising space, or the like. In this case, the plan receiving unit 131 receives various kinds of information input in the submission site as the plan information and the advertising space information.

Note that when the plan information is acquired by the plan receiving unit 131, the calculating unit 141 according to the embodiment calculates a predicted number of PV of content. Processing by the calculating unit 141 will be described later.

The service providing unit 132 presents the predicted number of PV calculated by the calculating unit 141 which will be described later and the plan information received by the plan receiving unit 131, and provides an auction service in which a right to display an advertisement on an advertising space to be set to content by the content creator is a bid target.

Specifically, when a request for an auction page is received from the advertiser terminal 20, the service providing unit 132 provides an auction page to the advertiser terminal 20. At this time, the service providing unit 132 provides an auction page including the predicted number of PV, content-plan of content, and information related to an auction for each advertising space.

For example, the service providing unit 132 acquires various kinds of information related to content being planned from the auction storage unit 121. In the case of the example of FIG. 4, the service providing unit 132 acquires content-plan, a predicted number of PV, advertising space information for each auction ID, a current price, a bidder ID, an end date and time, and the like for each plan ID from the auction storage unit 121. At this time, the service providing unit 132 acquires only various kinds of information corresponding to a plan ID having one or more auctions being held. Specifically, the service providing unit 132 specifies a plan ID corresponding to an auction ID that has the present date and time included in the auction period and that has no date information stored in the end date and time, and acquires various kinds of information corresponding to the specified plan ID from the auction storage unit 121.

Then, the service providing unit 132 generates a list page that is a web page on which a list of various kinds of information related to content being planned is displayed. Then, the service providing unit 132 transmits the generated list page to the advertiser terminal 20. As a result, the service providing unit 132 receives an acquisition request including a plan ID corresponding to content being planned selected from the list page from the advertiser terminal 20. In this case, the service providing unit 132 generates an auction page on which content-plan and the like are posted using various kinds of information corresponding to the plan ID included in the acquisition request, and provides the generated auction page to the advertiser terminal 20.

Furthermore, the service providing unit 132 receives bid information including a bidding price from the advertiser terminal 20 through the auction page. In this case, the service providing unit 132 stores the bidding price included in the bid information in the auction storage unit 121 in association with an auction ID indicating a bid target auction. At this time, the service providing unit 132 also stores a bidder ID corresponding to a bidder that is a transmission source of the bid information in the auction storage unit 121. Note that the service providing unit 132 may receive the bidder ID together with the bid information, or may use a login ID of the bidder or the like as the bidder ID. Furthermore, when an auction has been successfully performed, the service providing unit 132 stores a date and time on which the auction ended in the end date and time of the auction storage unit 121.

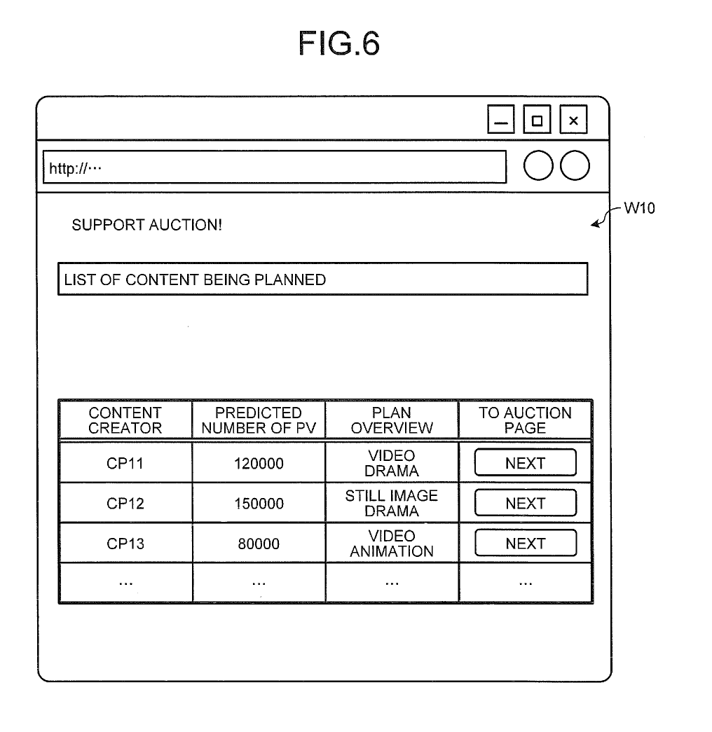

Here, FIG. 6 illustrates an exemplary list page according to the embodiment. As in the example illustrated in FIG. 6, the service providing unit 132 posts a list of a content creator that is planning to create content, a predicted number of PV of content, and a plan overview on a list page W10. Furthermore, the service providing unit 132 posts a “next” button for selecting content being planned on the list page W10. Note that the plan overview corresponds to a part or all of content-plan stored in the auction storage unit 121.

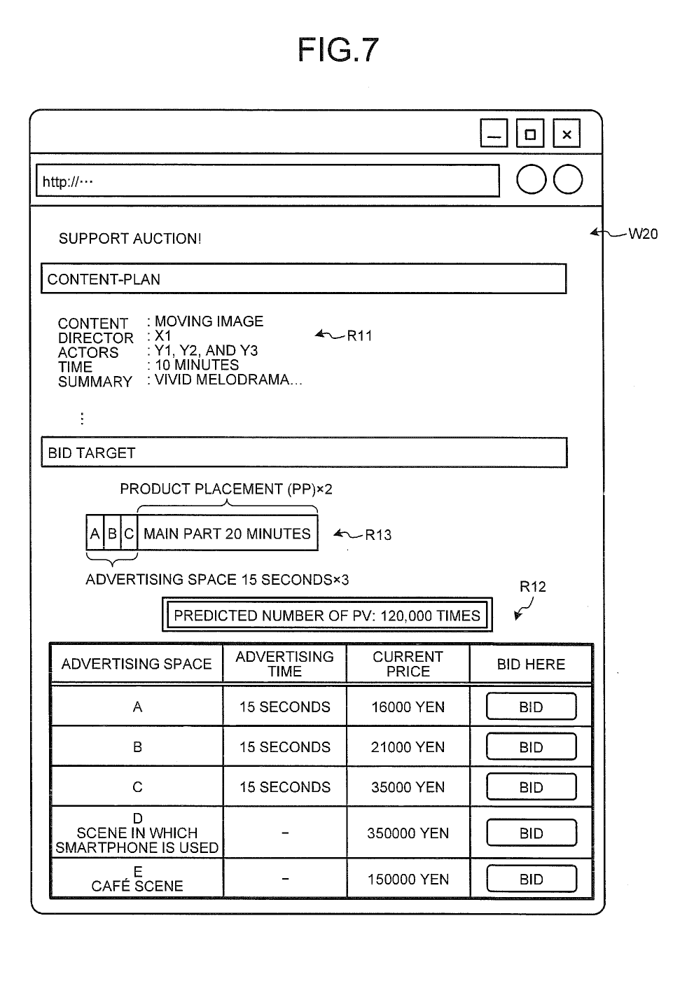

Then, when any of content being planned is selected in the list page W10 illustrated in FIG. 6, the service providing unit 132 delivers an auction page W20 illustrated in FIG. 7 to the advertiser terminal 20. FIG. 7 is a diagram illustrating an example of the auction page W20 according to the embodiment. FIG. 7 illustrates an example of the auction page W20 corresponding to the plan ID “P101” illustrated in FIG. 4. As in the example illustrated in FIG. 7, the service providing unit 132 posts content-plan stored in the auction storage unit 121 on a plan display field R11 of the auction page W20. Furthermore, the service providing unit 132 posts the predicted number of PV stored in the auction storage unit 121 in association with the plan ID “P101” on a bidding display field R12 of the auction page W20, and posts the advertising space information for each auction ID and the like. Furthermore, the service providing unit 132 posts an image diagram in which a reproduction position of an advertising space is visible on an image display field R13 of the auction page W20. As described above, when information related to a plurality of advertising spaces is included in the advertising space information, the service providing unit 132 posts all the advertising space information on the auction page W20, and individually holds an auction related to each advertising space.

Furthermore, here, although not illustrated, when a bidding button displayed on the bidding display field R12 is pressed down, the service providing unit 132 provides a bidding page for inputting a bidding price to the advertiser terminal 20. As a result, the service providing unit 132 receives the bid information including the bidding price from the advertiser terminal 20 through the bidding page.

Then, when all auctions related to the advertising spaces end, the service providing unit 132 assumes that all auctions have been officially completed. Specifically, even when some auctions among auctions related to the advertising spaces have ended, the service providing unit 132 assumes that such some auctions are provisionally completed, until all auctions are completed. In the case of the example illustrated in FIG. 7, the service providing unit 132 holds five auctions related to the advertising spaces A to E. Here, when a period of time of holding each auction is different or when a buyout price is set to each auction, the five auctions do not necessarily end at the same time. For example, among the five auctions, only an auction related to the advertising space A is assumed to have ended. In this case, the service providing unit 132 assumes that the auction related to the advertising space A is provisionally completed and a winning bidder is provisionally decided, until all the five auctions are completed. Then, after all the five auctions have ended, the service providing unit 132 assumes that all auctions have been officially completed, and finally settles a winning bidder of each auction. That is, the service providing unit 132 stores the end date and time in the auction storage unit 121 each time a winning bidder is decided and an auction ends, but when the end dates and times corresponding to all auction IDs among a plurality of auction IDs associated with one plan ID are stored, all auctions are assumed to have been officially completed.

Here, when some auctions among a plurality of auctions are not completed, the service providing unit 132 may assumes that all auctions are not completed. Examples of the aspect where an auction is not completed include a case in which the number of bids is none and a case in which the highest amount of a bidding price does not reach a lowest winning bid price. In this case, the service providing unit 132 may hold all auctions again. Alternatively, the service providing unit 132 may hold again only some auctions that have not been completed. At this time, the service providing unit 132 may set a lowest winning bid price lower than the last lowest winning bid price in an auction to be held again. Alternatively, when some auctions among a plurality of auctions have not been completed, the service providing unit 132 may notify the content creator of the fact. Then, the service providing unit 132 may hold all auctions again or may decide whether only some auctions that have not been completed are held again, according to an instruction from the content creator.

Note that the list page W10 illustrated in FIG. 6 is not limited to the illustrated example. For example, the service providing unit 132 may post a name of a content creator and the like. Furthermore, the auction page W20 illustrated in FIG. 7 is not limited to the illustrated example. For example, the service providing unit 132 may post a name of a content creator and the like on the plan display field R11. Furthermore, for example, the service providing unit 132 may display information (for example, a company's name or a type of business) related to a bidder that is bidding the highest price. Furthermore, for example, the content creator may set a target amount of a winning bid price in the plan information as an assumed amount of a cost for creating content. In this case, the service providing unit 132 may post the target amount of the winning bid price on the plan display field R11. Furthermore, for example, the service providing unit 132 may post a period of time of holding an auction on the bidding display field R12. Furthermore, for example, the service providing unit 132 may not post an image diagram on the image display field R13.

The winning bid amount managing unit 133 manages the winning bid amount received from the winning bidder who has successfully bid the right. Specifically, even when the winning bid amount is received from the winning bidder, the winning bid amount managing unit 133 instantly stores the entire winning bid amount, without sending the winning bid amount to the content creator. Whenever the content creator charges for the creation of content, the winning bid amount managing unit 133 sends the amount of money corresponding to the charge from the stored reserve price to the content creator. For example, the winning bid amount managing unit 133 receives, from the creator terminal 10, charge data, such as clothing expenses, filming expenses, or food expenses which have been actually used to create content, or food expenses which will be used to create content immediately. Then, the winning bid amount managing unit 133 sends the amount of money corresponding to the received charge data to the content creator. In addition, the winning bid amount managing unit 133 manages winning bid amount using the current price (that is, the highest bid price) stored in the auction storage unit 121.

Thus, the winning bid amount managing unit 133 does not instantly send the winning bid amount received from the winning bidder to the content creator, but gradually sends the winning bid amount in response to the request from the content creator. Therefore, the winning bid amount managing unit 133 can prevent the winning bid amount from being sent to the content creator who does not create content. As a result, the winning bid amount managing unit 133 can prevent the abuse of the auction service provided by the service providing apparatus 100.

In addition, when the total amount of money charged by the content creator is less than the winning bid amount, the winning bid amount managed by the winning bid amount managing unit 133 is left over. In this case, the winning bid amount managing unit 133 may send the surplus money to the content creator after the content creator has created the content. Accordingly, since the winning bid amount managing unit 133 pays the content creator compensation for the completion of the content, it is possible to improve the creative impulse of the content creator.

In addition, although the example where the winning bid amount managing unit 133 transfers winning bid amount to the content creator is illustrated in the example described above, the winning bid amount managing unit 133 may perform only processing for calculating the amount of money transferred to the content creator. Then, the administrator or the like of the service providing apparatus 100 may transfer to the content creator the amount of money calculated by the winning bid amount managing unit 133.

The content receiving unit 134 receives the content corresponding to the plan information from the content creator (for example, the creator terminal 10). For example, when the content creator which has transmitted the plan information completes content, the content receiving unit 134 receives a completed content. In addition, the content receiving unit 134 receives advertisement data which is incorporated into the advertising space from the winning bidder (for example, the advertiser terminal 20).

Note that the winning bidder having the right of displaying an advertisement may transfer this right to another advertiser. In this case, the content receiving unit 134 receives advertisement data not only from the winning bidder but also from an advertiser who has the right of displaying an advertisement. Hereinafter, it is assumed that even when simply expressed as “the winning bidder”, the winning bidder can also include the advertiser to whom the right of displaying an advertisement has been transferred.

The generating unit 135 combines the content and the advertisement data received from the content receiving unit 134 to generate composite content. Specifically, the generating unit 135 generates composite content after all auctions corresponding to the predetermined plan information (plan ID) are successful in the auction service provided by the service providing unit 132. In this case, the generating unit 135 generates composite content by incorporating the advertisement data of the advertiser, who has made a successful bid for the right to display an advertisement in an advertising space set to the content created by the content creator, in the advertising space based on the advertising space information stored in the auction storage unit 121.

In addition, as described above, the advertising space for which the advertiser has made a successful bid may correspond to a cast frame in which an advertising product appears in an image, as in the product placement. In this case, for example, the content creator receives an advertising product from the advertiser, who is a winning bidder, and creates the content, such as a moving image, using the received advertising product. Therefore, when the advertising space is the product placement, the content creator creates composite content including the advertisement data. That is, the content received by the content receiving unit 134 may correspond to composite content. For this reason, the generating unit 135 does not perform the process of generating the composite content when the advertising space set to the content is only the product placement. In other words, the generating unit 135 performs the above process of generating the composite content when advertising spaces that can be incorporated into the finished product of the content, such as the advertising spaces A to C illustrated in FIG. 1 and the like, are set to the content.

The transmitting unit 136 transmits the composite content generated by the generating unit 135 or the composite content received by the content receiving unit 134 to the distribution server 30. As a result, the distribution server 30 distributes the composite content, in which the advertisement data is incorporated, to the user terminal 40 in response to a request from the user terminal 40.

The calculating unit 141 calculates the predicted number of PV that is the predicted value of the number of times by which content being planned is viewed by users. Specifically, when the plan information is received by the plan receiving unit 131, the calculating unit 141 calculates the predicted number of PV based on the received plan information and various kinds of information stored in the history information storage unit 122. Then, the calculating unit 141 stores the calculated predicted number of PV in the auction storage unit 121.

As an aspect, the calculating unit 141 calculates the predicted number of PV of content corresponding to the plan information based on the views of content having created previously by the content creator that has transmitted the plan information. Specifically, the calculating unit 141 specifies created content corresponding to a creator ID of the content creator that has transmitted the plan information among the created content stored in the history information storage unit 122. Then, the calculating unit 141 calculates the predicted number of PV of content being planned based on the views corresponding to the specified created content. For example, the calculating unit 141 calculates an average value of the views corresponding to the created content as the predicted number of PV. This is because the number of PV of the content, which is created by the same content creator, is considered to be within a certain range.

The above calculation process will be described with reference to the example of FIG. 5. Here, the plan information is assumed to be transmitted by the content creator CP11. In this case, the calculating unit 141 specifies the created content “CD11” and “CD12” having the creator ID of “CP11”. Then, the calculating unit 141 calculates a sum “115000” of the numbers of views of the created content “CD11”, and a sum “125000” of the numbers of views of the created content “CD12”. Then, the calculating unit 141 calculates an average value “120000” of both sums as the predicted number of PV. Note that the calculating unit 141 may calculate a value obtained by subtracting a predetermined percentage from the average value of the views as the predicted number of PV.

Furthermore, as another aspect, the calculating unit 141 according to the embodiment calculates the predicted number of PV of content corresponding to the plan information based on the views of created content corresponding to the plan information received by the plan receiving unit 131 among all created content (that is, created content having created previously by various content creators as well as the content creator that has transmitted the plan information) stored in the history information storage unit 122. Specifically, the calculating unit 141 specifies created content that is identical in a content category included in the plan information, and calculates the predicted number of PV based on the views corresponding to the specified created content. This is because the number of PV of content that is identical in a category is likely to be within a certain range. For example, content related to a drama is considered to tend to be generally viewed about 100,000 times, and a content related to an animation is considered to tend to be generally viewed about 50,000 times.

The above calculation process will be described with reference to the example of FIG. 5. Here, the content category included in the plan information is assumed to be a “drama”. In this case, the calculating unit 141 specifies the created content “CD11” and “CD21” having the category of a “drama”. Then, the calculating unit 141 calculates a sum “115000” of the numbers of views of the created content “CD11”, and calculates a sum “30000” of the numbers of views of the created content “CD21”. Then, the calculating unit 141 calculates an average value “72500” of both sums as the predicted number of PV.

The acquiring unit 142 acquires various kinds of information used when calculating the predicted number of PV of content. Specifically, the acquiring unit 142 stores the composite content generated by the generating unit 135 in the created content of the history information storage unit 122 so as to match the creator ID of the content creator. That is, the acquiring unit 142 stores the composite content generated by the generating unit 135 in the history information storage unit 122 as content created in the past by the content creator. However, the acquiring unit 142 is not limited to this example, and may store the content received by the content receiving unit 134 in the created content of the history information storage unit 122.

Furthermore, the acquiring unit 142 periodically accesses the distribution server 30, and acquires the number of deliveries for each piece of composite content from the distribution server 30. Then, the acquiring unit 142 stores the number of deliveries of each piece of composite content in the views of the history information storage unit 122 in association with the composite content (created content). At this time, the acquiring unit 142 accumulates the number of deliveries for each piece of composite content acquired from the distribution server 30, and stores the views for each predetermined period of time (for example, one month) in the views of the history information storage unit 122.

### 4. Service Providing Process

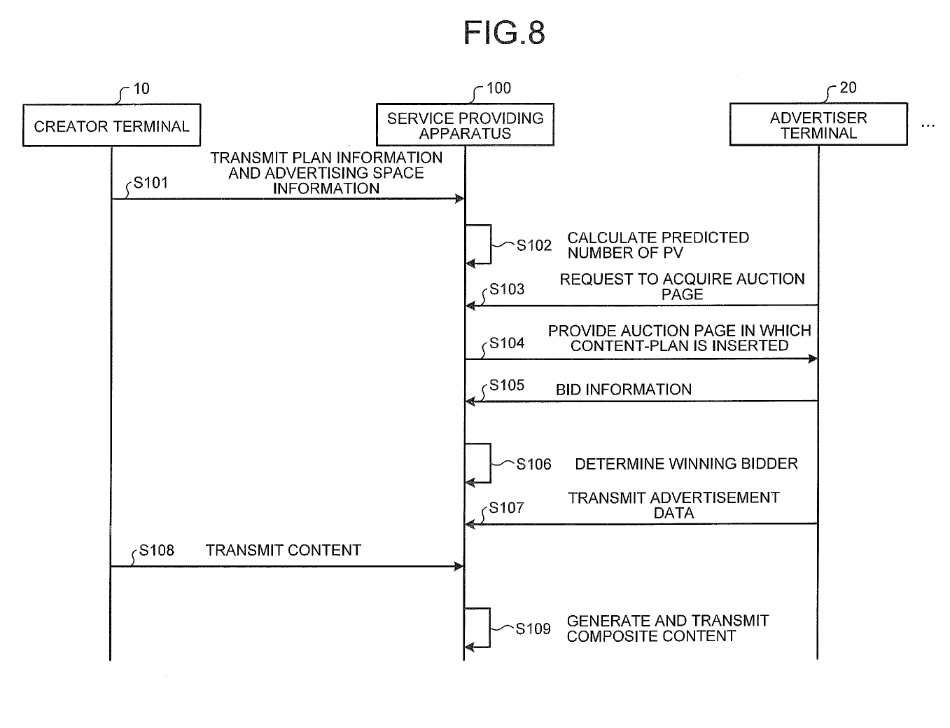

Next, a service providing process by the service providing system 1 according to the embodiment will be described with reference to FIG. 8. FIG. 8 is a sequence diagram illustrating the service providing process by the service providing system 1 according to the embodiment. Note that in FIG. 8, only one advertiser terminal 20 is illustrated, but practically, there is a plurality of advertiser terminals 20.

As illustrated in FIG. 8, the content creator transmits the plan information and the advertising space information to the service providing apparatus 100 using the creator terminal 10 (step S101). In this case, the service providing apparatus 100 stores the plan information and the advertising space information in the auction storage unit 121.

Note that FIG. 8 illustrates an example in which the content creator transmits the plan information and the advertising space information at the same time. However, the content creator may transmit the plan information and the advertising frame information at the different timing. For example, the content creator may transmit the advertising space information to the service providing apparatus 100 after transmitting the plan information. Furthermore, for example, the content creator may transmit the plan information and the advertising space information to the service providing apparatus 100 by inputting various kinds of information to the above-described submission site. In this case, the content creator may first input the plan information to the submission site and then input the advertising space information to the submission site on a different date or the like.

Subsequently, the service providing apparatus 100 calculates the predicted number of PV of content corresponding to the plan information based on the plan information received in step S101 (step S102).

Subsequently, the service providing apparatus 100 receives the request for an auction page from the advertiser terminal 20 (step S103). For example, the service providing apparatus 100 receives the request for an auction page through the list page illustrated in FIG. 6. In this case, the service providing apparatus 100 provides an auction page on which the predicted number of PV of content and content-plan of content are posted to the advertiser terminal 20 (step S104). Then, the service providing apparatus 100 receives bid information including a bidding price from the advertiser terminal 20 through the auction page (step S105). In this manner, the service providing apparatus 100 receives the bid information from the plurality of advertiser terminal 20.

Then, the service providing apparatus 100 determines a winning bidder based on the bid information received from the advertiser terminal 20 (step S106). For example, the service providing apparatus 100 determines an advertiser that is bidding the highest price at a date and time on which a period of time of holding an auction expired, as the winning bidder. Then, the service providing apparatus 100 manages the winning bid amount paid by the winning bidder. Thereafter, when the content creator has asked for payment of a production cost, the service providing apparatus 100 remits the billed amount to the content creator from the winning bid amount.

Furthermore, the winning bidder transmits advertisement data to the service providing apparatus 100 using the advertiser terminal 20 (step S107). Furthermore, when content has been created, the content creator transmits the content to the service providing apparatus 100 using the creator terminal 10 (step S108).

Then, the service providing apparatus 100 generates composite content by incorporating the advertisement data received from the advertiser into the content received from the content creator, and transmits the generated composite content to the distribution server 30 (step S109).

### 5. Modified Example

The service providing system 1 according to the above embodiment may be carried out in various different modes other than the above embodiment. Now, hereinafter, other embodiment of the service providing system 1 will be described.

5-1. Technique of Calculating the Predicted Number of PV

The above embodiment has described the example in which the service providing apparatus 100 calculates the predicted number of PV based on the prediction element, such as “views of created content matched with a content creator to content being planned” or “views of created content matched with a category of content being planned”. However, a calculating unit 141 of a service providing apparatus 100 may calculate the predicted number of PV using a plurality of prediction elements.

For example, the calculating unit 141 may calculate the predicted number of PV based on “views of created content matched with a content creator of content being planned” and “views of created content matched with a category of content being planned”. An example where the calculating unit 141 generates a regression model (hereinafter, referred to as a “PV number model M1”) from both the prediction elements and calculates the predicted number of PV from the generated PV number model M1 will be described below.

First, the calculating unit 141 generates the PV number model M1, which shows the predicted number of PV by the creator ID or the category, by performing regression analysis using the views stored in the history information storage unit 122 as a dependent variable (objective variable) and the creator ID or the category stored in the history information storage unit 122 as an independent variable (explanatory variable). For example, the PV number model M1 calculated by the calculating unit 141 is expressed by the following Expression (1).

pv=a0·x0+a1·x1 (1)

In the above Expression (1), “pv” indicates the views stored in the history information storage unit 122. Furthermore, “x0” indicates the average value of the views for each creator ID. In the case of the example of FIG. 5, the views of the created content “CD11” created by the content creator CP11 is “115000”, and the views of the created content “CD12” is “125000”. Thus, “x0” corresponding to the content creator CP11 becomes “120000”. Furthermore, “x1” indicates an average value of the views for each category. In the case of the example of FIG. 5, the views of the created content “CD11” corresponding to the category “drama” is “115000”, and the views of the created content “CD21” is “30000”. Thus, “x1” corresponding to the category “drama” becomes “72500”.

For example, in the case of the created content “CD11” illustrated in FIG. 5, the number of “pv” is “115000”. Furthermore, as in the above example, “x0” corresponding to the content creator CP11 is “120000”, and, “x1” corresponding to the category “drama” is “72500”. In this case, the above Expression (1) is expressed as in the following Expression (2).

pv=a0·x0+a1·x1 (1)

115000=a0·(120000)+a1·(72500) (2)

The calculating unit 141 also obtains the same expression as the above Expression (2) for the created content “CD12” and “CD21”. Then, the calculating unit 141 calculates “a0” and “a1” that approximately satisfy each expression by performing regression analysis on the expression corresponding to the respective created content, and generates the PV number model M1 by applying the calculated “a0” and “a1” to the above Expression (1).

Then, when plan information is received by a plan receiving unit 131, the calculating unit 141 calculates the predicted number of PV using the PV number model M1 expressed by the above Expression (1). Specifically, the calculating unit 141 substitutes an average value of the views of created content corresponding to the content creator that has transmitted the plan information into “x0” of the above Expression (1). Furthermore, the calculating unit 141 substitutes an average value of the views of created content corresponding to a category included in the plan information into “x1” of the above Expression (1). As a result, the calculating unit 141 calculates the predicted number of PV of content indicated by the plan information.

As described above, the service providing apparatus 100 can calculate the predicted number of PV with a high degree of accuracy using a plurality of prediction elements. As a result, the service providing apparatus 100 can provide a service having a higher value-added to an advertiser.

Note that in the above Expression (1), a linear model has been described as an example, but the calculating unit 141 may use a “log linear” model as in the following Expression (3) instead of the linear model.

pv=1/{1+exp(−(a0·x0+a1·x1))} (3)

5-2. Update of Predicted Number of PV (1)

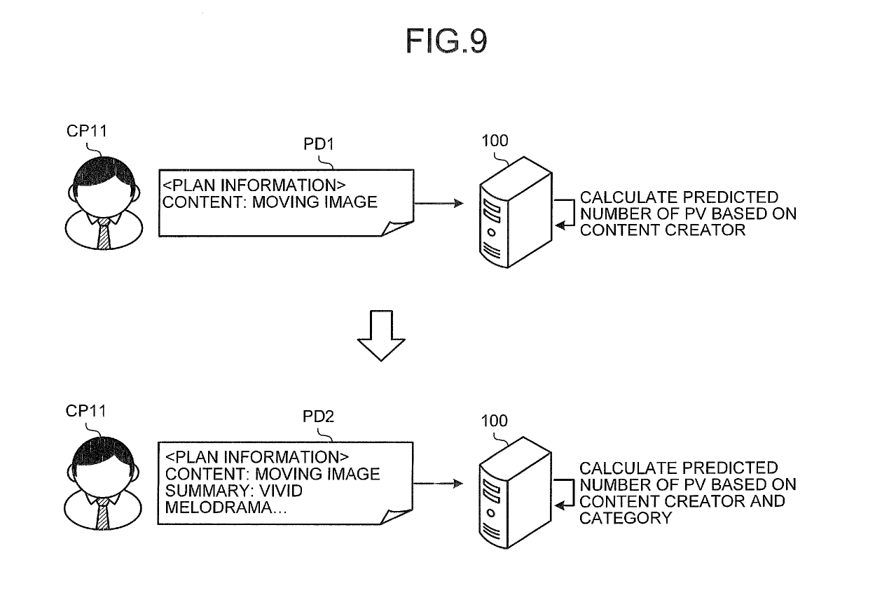

Furthermore, the plan receiving unit 131 of the service providing apparatus 100 may receive the plan information from the content creator more than once in a stepwise manner. In this case, each time new plan information is received by the plan receiving unit 131, the calculating unit 141 may calculate the predicted number of PV based on the views of created content corresponding to the new plan information. In this case, the calculating unit 141 updates the predicted number of PV stored in the auction storage unit 121 to the newly calculated predicted number of PV. Furthermore, a service providing unit 132 presents the predicted number of PV newly calculated by the calculating unit 141, and provides an auction service. This point will be described with reference to FIG. 9.

FIG. 9 is a diagram illustrating an exemplary service providing process according to a modified example. As illustrated in FIG. 9, the content creator CP11 first transmits plan information PD1 to the service providing apparatus 100 using a creator terminal 10. The plan information PD1 includes information related to a type of content but does not include other information (for example, a director, an actor, and a summary). In this case, the calculating unit 141 calculates the predicted number of PV of content that is being planned by the content creator CP11 based on the plan information PD1. For example, the calculating unit 141 calculates the predicted number of PV using the views of created content having created previously by the content creator CP11.

Thereafter, the service providing unit 132 of the service providing apparatus 100 starts to provide an auction service. At this point in time, the service providing unit 132 posts the predicted number of PV calculated from the prediction element such as the “views of created content that is identical in a content creator to content being planned”, on an auction page.

Subsequently, the content creator CP11 transmits plan information PD2 to the service providing apparatus 100. The plan information PD2 includes information related to a summary as well as a type of content. That is, the plan information PD2 includes information complementary to the plan information PD1. In this case, the calculating unit 141 newly calculates the predicted number of PV based on the plan information PD2. For example, the calculating unit 141 calculates the predicted number of PV using the PV number model M1 described above. That is, the calculating unit 141 calculates the predicted number of PV using more prediction elements than those at a point in time at which the plan information PD1 is received. Thus, the calculating unit 141 can calculate the predicted number of PV with a higher degree of accuracy than at a point in time at which the plan information PD1 is received. Then, the service providing unit 132 posts the predicted number of PV calculated from the PV number model M1 by the calculating unit 141 on an auction page to be delivered thereafter to the advertiser terminal 20.

As described above, the service providing apparatus 100 may receive the plan information more than once in a stepwise manner. As a result, the service providing apparatus 100 can implement an auction service practical for the content creator. For example, even when content-plan is not sufficiently reviewed yet, the content creator transmits a brief version of the content-plan to the service providing apparatus 100 so that an auction can be held. Then, when the plan information is received in a stepwise manner, the service providing apparatus 100 updates the predicted number of PV each time the plan information is received. As a result, the service providing apparatus 100 can provide the predicted number of PV having a high hitting ratio to the advertiser (the bidder) each time the plan information is enriched.

5-3. Update of Predicted Number of PV (2)

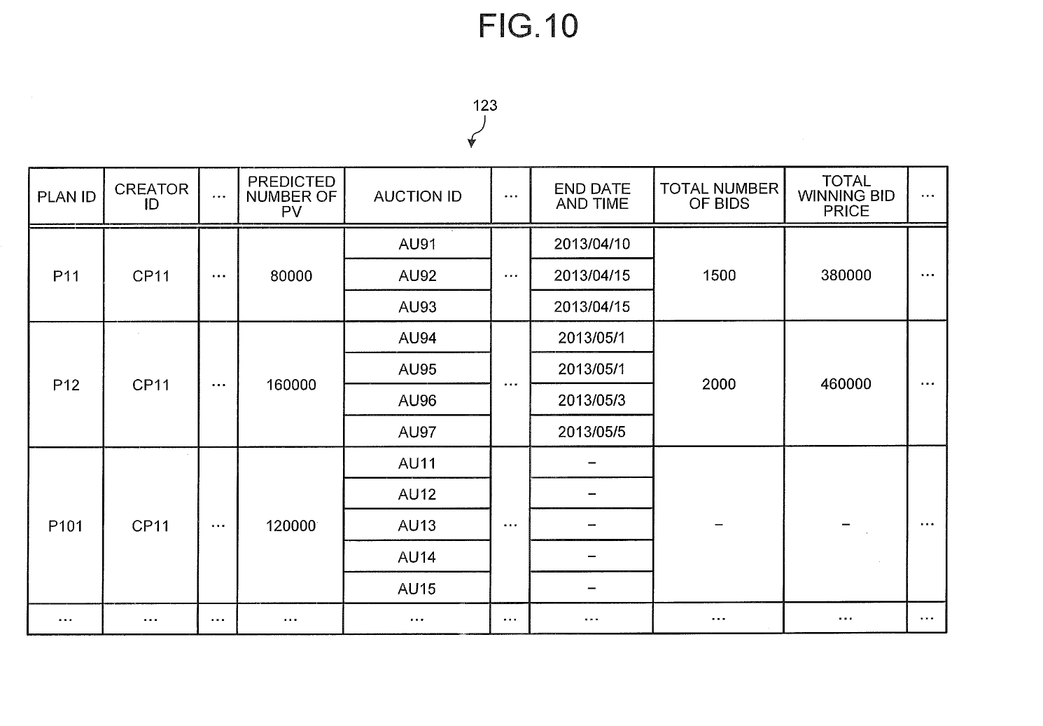

Furthermore, FIG. 9 has illustrated the example in which the service providing apparatus 100 updates the predicted number of PV when the plan information is received in a stepwise manner. However, the service providing apparatus 100 may update the predicted number of PV even when the plan information is not received in a stepwise manner. Specifically, the calculating unit 141 may periodically calculate the predicted number of PV based on the views of created content corresponding to auction information such as the number of bids or the highest bidding price while an auction service is being provided by the service providing unit 132. In this case, the service providing unit 132 presents the predicted number of PV newly calculated by the calculating unit 141, and provides the auction service. This point will be described with reference to FIG. 10.

FIG. 10 is a diagram illustrating an example of an auction storage unit 123 according to the modified example. The service providing apparatus 100 according to the modified example includes the auction storage unit 123 illustrated in FIG. 10 instead of the auction storage unit 121 illustrated in FIG. 4. As illustrated in FIG. 10, the auction storage unit 123 stores information such as the “total number of bids” and a “total winning bid price” as exemplary auction information. Note that although not illustrated in FIG. 10, the auction storage unit 123 stores the “content-plan”, the “advertising space information”, the “auction period”, the “current price”, the “bidder ID”, and the “end date and time” illustrated in FIG. 4 as well.

The “total number of bids” indicates a sum of the numbers of bids that have been made in auctions corresponding to the plan ID. The “total winning bid price” indicates a total amount of the winning bid price in auctions corresponding to the plan ID. The “total number of bids” and the “total winning bid price” are stored by the service providing unit 132 after all auctions corresponding to the plan ID have ended. FIG. 10 illustrates an example in which auctions corresponding to plan IDs “P11” and “P12” have ended, and auctions corresponding to a plan ID “P101” have not ended. That is, the auction storage unit 123 illustrated in FIG. 10 stores various kinds of information corresponding to the plan ID “P11” and “P12” as history information.

Here, the calculating unit 141 generates a regression model (hereinafter, assumed to be a “PV number model M2”) for calculating the predicted number of PV from the total number of bids or a total winning bid price based on an auction that has ended and that is stored in the auction storage unit 123. For example, the calculating unit 141 performs regression analysis, assuming that the views stored in the history information storage unit 122 is a dependent variable (an objective variable) and the total number of bids or a total winning bid price stored in the auction storage unit 123 is an independent variable (an explanatory variable), and thus generates the PV number model M2 representing the predicted number of PV by the total number of bids or a total winning bid price.

Then, the calculating unit 141 periodically updates the predicted number of PV using the PV number model M2 after provision of the auction service is held. Hereinafter, a process of updating the predicted number of PV will be described using the plan ID “P101” illustrated in FIG. 10 as an example. Note that here, auctions corresponding to the plan ID “P101” are assumed to be being held.

First, the calculating unit 141 calculates the total number of bids and a total amount of the current price (hereinafter, assumed to be a “total bidding price”) in auctions being held that are identified by auction IDs “AU11” to “AU15” corresponding to the plan ID “P101”. For example, the total number of bids and the total bidding price are temporarily stored in a predetermined storage unit (that may be the auction storage unit 123 or the like) by the service providing unit 132 while the auctions are being held.

Then, the calculating unit 141 predicts the total number of bids when the auctions being held have ended, based on the calculated total number of bids. Specifically, the calculating unit 141 predicts the total number of bids and a total winning bid price at the time when the auctions ended, based on a period of time of holding an auction and the number of days elapsed from a date of holding an auction to the present date. For example, the calculating unit 141 can predict the total number of bids from a period of time of holding an auction and the number of elapsed days based on a history of auctions having held previously. For example, the service providing apparatus 100 is assumed to store a period of time of holding an auction and the total number of bids and a total bidding price for each number of elapsed days in each auction as auction history information related to an auction having held previously. In this case, the calculating unit 141 can predict the total number of bids and a total bidding price when each auction being held has ended from a period of time of holding an auction and the number of elapsed days in each auction being held by analyzing a relation between a period of time of holding an auction and the number of elapsed days and the total number of bids and a total bidding price stored in the auction history information. Then, the calculating unit 141 calculates the predicted number of PV by substituting the predicted total number of bids and total winning bid price into the PV number model M2.

As described above, the service providing apparatus 100 may sequentially calculate the predicted number of PV based on various kinds of information (the number of bids or the bidding price) related to the auction while the auction service is being provided. Here, when content-plan is excellent, many users are expected to view content, and thus the number of bids and the winning bid price of an auction tend to increase. Then, when content-plan is actually excellent, many users generally tend to view content. That is, it can be said that the total number of bids and a total winning bid price predicted by the calculating unit 141 while an auction is being held indicate an evaluation index of content-plan. Then, it can be said that the above PV number model M2 indicates a relation between the evaluation index of the content-plan and the actual views. As a result, the calculating unit 141 can calculate the predicted number of PV with a high degree of accuracy using the PV number model M2.

5-4. Prediction Element Used in Prediction Process

Furthermore, the above embodiment has described the example in which the service providing apparatus 100 uses the “views of created content that is identical in a content creator to content being planned”, the “views of created content that is identical in a category to content being planned”, the “total number of bids”, the “total winning bid price”, or the like when calculating the predicted number of PV. However, the calculating unit 141 of the service providing apparatus 100 may calculate the predicted number of PV using a prediction element other than the above prediction elements.

For example, the calculating unit 141 may calculate the predicted number of PV using a prediction element such as the “views of created content matched with a director to content being planned”, the “views of created content matched with an actor to content being planned”, the “views of created content that is equivalent in a reproduction time to content being planned”, the “views of created content that is equivalent in the number of advertising spaces (within a range of a predetermined number) to be set to content being planned”, or the “views of created content that is similar in a position of an advertising space to be set to content being planned”. In this case, the calculating unit 141 generates the PV number model using these prediction elements, and calculates the predicted number of PV from the generated PV number model.

5-5. Predicted Number of PV for Each Period of Time

Furthermore, the above-described service providing apparatus 100 may calculate the predicted number of PV for each predetermined period of time. For example, the calculating unit 141 calculates the predicted number of PV each time one month elapses after composite content has been delivered. This point will be described using the example of FIG. 5.

As illustrated in FIG. 5, the history information storage unit 122 stores the monthly views. The calculating unit 141 specifies created content having created previously by the content creator that has transmitted the plan information, when the plan information is received by the plan receiving unit 131. Further, the calculating unit 141 acquires the views during a period of time until a first one month elapses after the created content has been delivered among the views corresponding to the specified created content. Then, the calculating unit 141 uses an average value of the views during the first one month corresponding to respective created content or the like as a predicted number of PV during the first one month in content corresponding to the plan information received by the plan receiving unit 131. Similarly, the calculating unit 141 calculates the monthly predicted number of PV in content corresponding to the plan information using the monthly views in respective created content. In this case, the service providing unit 132 generates an auction page on which the monthly predicted number of PV calculated by the calculating unit 141 is posted. At this time, the service providing unit 132 may post a graph representing the monthly predicted number of PV on the auction page.

Note that the above example has described the example in which the monthly predicted number of PV is calculated. However, the calculating unit 141 may calculate the predicted number of PV for each predetermined period of time (for example, a week, two weeks, two months, or the like) rather than monthly. Furthermore, the above example has described the example in which the calculating unit 141 calculates the predicted number of PV using the “views of created content that is identical in a content creator to content being planned”. However, the embodiment of calculating the predicted number of PV for each predetermined period of time can also be applied to [5-1. Technique of calculating predicted number of PV], [5-2. Update (1) of predicted number of PV], [5-3. Update (2) of predicted number of PV], or [5-4. Prediction element used in prediction process]. That is, the calculating unit 141 may calculate the predicted number of PV for each predetermined period of time using the “views of created content that is identical in a category to content being planned”, the “total number of bids”, the “total winning bid price”, or the like.

As described above, the service providing apparatus 100 calculates the predicted number of PV for each predetermined period of time, and thus can provide transition of the predicted number of PV in content being planned to the advertiser. For example, some advertisers may desire to display an advertisement on content in which an average number of PV is obtained for a long period of time. Furthermore, for example, some advertisers may desire to display an advertisement on content in which a large number of PV is obtained for a short period of time immediately after delivery. The service providing apparatus 100 calculates the predicted number of PV for each predetermined period of time, and thus can provide information serving as a reference at the time of bidding to such advertisers. As a result, the service providing apparatus 100 can provide a service having an value-added to the advertiser.

5-6. PV Guarantee

Furthermore, the service providing apparatus 100 may provide an auction service of guaranteeing a winning bidder the number of times at which an advertisement is viewed by a user (that is, the number of deliveries of composite content).

For example, the service providing unit 132 may guarantee the advertiser the number of PV obtained by subtracting a predetermined percentage from the predicted number of PV calculated by the calculating unit 141 (for example, a 20 percent decrease). For example, when the predicted number of PV calculated by the calculating unit 141 is “100000”, the service providing unit 132 may guarantee “80000” that is a 20 percent decrease from the predicted number of PV “100000”. At this time, the service providing unit 132 may set a time limit for achieving the guaranteed number of PV. For example, the service providing unit 132 sets a period of time from a delivery start date of composite content to a predetermined date as the time limit for achieving the guaranteed number of PV.

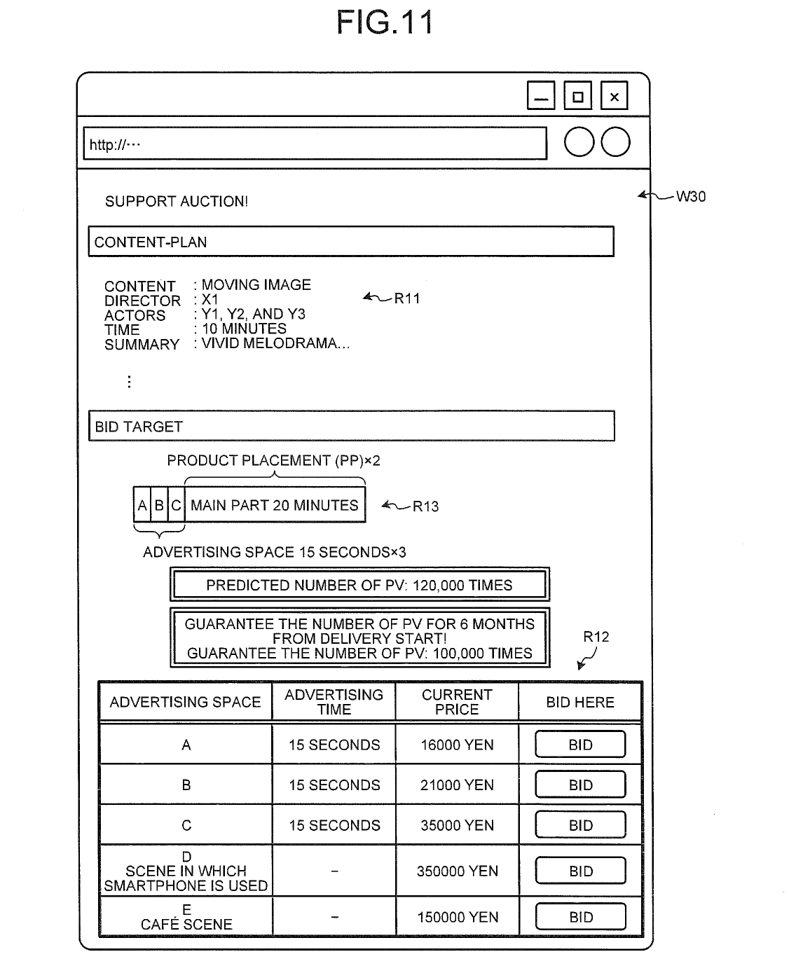

In this case, the service providing unit 132 generates an auction page on which the guaranteed number of PV is posted. FIG. 11 illustrates an example of an auction page W30 generated by the service providing unit 132 according to the modified example. As in the example illustrated in FIG. 11, the service providing unit 132 posts the predicted number of PV calculated by the calculating unit 141 and the guaranteed number of PV calculated based on the predicted number of PV on a bidding display field R12 of the auction page W30. FIG. 11 illustrates an example in which the PV number of 100,000 is guaranteed for six months after a delivery of composite content has started.

As described above, the service providing apparatus 100 provides the auction service of guaranteeing the number of PV, and thus can make the advertiser feel at ease about bidding. As described above, in the auction service provided by the service providing apparatus 100, a right to display an advertisement on the content at a planning stage is a bid target. Thus, it is difficult for the advertiser that is a bidder to predict the number of deliveries of content at the time of bidding. However, since the service providing apparatus 100 guarantees the number of PV and thus can make the advertiser feel at ease about bidding, the service providing apparatus 100 can provide a service having a high value-added to the advertiser.

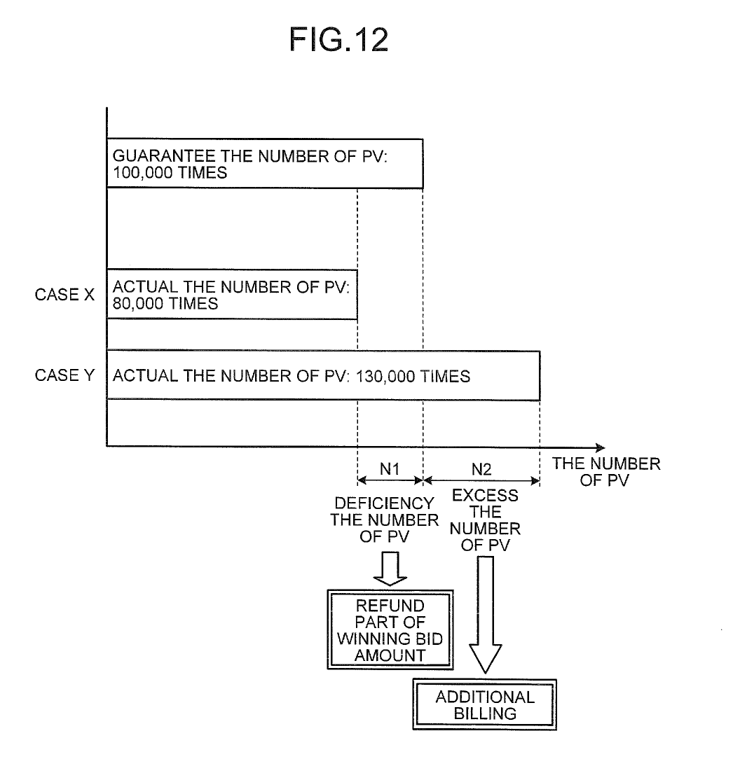

Note that, in the case of guaranteeing the number of PV, the service providing apparatus 100 may financially correspond to the advertiser that is a winning bidder, according to whether to having enabled the number of PV to be guaranteed. This point will be described with reference to FIG. 12. FIG. 12 is a diagram illustrating an exemplary accounting process according to the modified example. In the example of FIG. 12, the guaranteed number of PV is assumed to be 100,000. Here, the guaranteed number of PV is assumed to be the number of PV that has to be achieved during a guaranteed period of time from a delivery start of composite content to a predetermined date.

Here, the number of PV (hereinafter, assumed to be an “actual PV number”) of actual advertisement data during the guaranteed period of time is assumed to have been 80,000 as illustrated in a case X of FIG. 12. In this case, a winning bid amount managing unit 133 of the service providing apparatus 100 calculates a deficiency number of PV N1 by subtracting the actual number of PV from the guaranteed number of PV. Then, the winning bid amount managing unit 133 calculates a refund amount corresponding to a part or all of a winning bid amount for the advertiser that is the winning bidder, according to the deficiency number of PV N1. For example, the winning bid amount managing unit 133 calculates an amount obtained by multiplying the deficiency number of PV N1 by a predetermined value as a refund amount.

Meanwhile, the actual number of PV during the guaranteed period of time is assumed to have been 130,000 as illustrated in a case Y of FIG. 12. In this case, the winning bid amount managing unit 133 calculates an excess number of PV N2 by subtracting the guaranteed number of PV from the actual number of PV. Then, the winning bid amount managing unit 133 may calculate an additional billing amount that is additionally billed to the advertiser that is the winning bidder, according to the excess number of PV N2. For example, the winning bid amount managing unit 133 calculates an amount obtained by multiplying the excess number of PV by a predetermined value as the additional billing amount.

Note that the service providing apparatus 100 may control so as to stop the delivery of advertisement data at a point in time at which the actual number of PV exceeds the guaranteed number of PV during the guaranteed period of time. Specifically, for example, a generating unit 135 of the service providing apparatus 100 generates composite content CD11 into which advertisement data G1 of the advertiser that is the winning bidder is incorporated and composite content CD12 into which the advertisement data G1 is not incorporated. At this time, the generating unit 135 may generate composite content CD12 into which advertisement data provided by the content creator is incorporated instead of the advertisement data G1, and may generate composite content CD12 in which an advertising space into which the advertisement data G1 is incorporated is skipped. Then, the service providing apparatus 100 transmits the composite content CD11 and CD12 to a distribution server 30 together with the guaranteed number of PV. As a result, the distribution server 30 delivers the composite content CD11 into which the advertisement data G1 is incorporated to a user terminal 40 until the actual number of PV reaches the guaranteed number of PV. Meanwhile, the distribution server 30 delivers the composite content CD12 into which the advertisement data G1 is not incorporated to the user terminal 40 after the actual number of PV reaches the guaranteed number of PV.

5-7. Prediction Accuracy of Number of PV

Furthermore, the service providing apparatus 100 described above may calculate prediction accuracy that is a probability that the predicted number of PV will be correct. For example, the calculating unit 141 stores a predicted number of PV having calculated previously for created content having created previously, a prediction element having used in calculating the predicted number of PV previously, the actual number of PV of created content, and an error number of PV that is an error between the predicted number of PV and the actual number of PV in a predetermined storage unit as prediction history information. Then, when the predicted number of PV of content being planned is calculated, the calculating unit 141 acquires the error number of PV corresponding to the prediction element used in calculating the predicted number of PV from the prediction history information. Then, the calculating unit 141 calculates the prediction accuracy of the predicted number of PV based on the error number of PV acquired from the prediction history information. For example, the calculating unit 141 calculates high prediction accuracy as an average value of the error number of PV acquired from the prediction history information decreases, and calculates low prediction accuracy as the average value of the error number of PV increases.

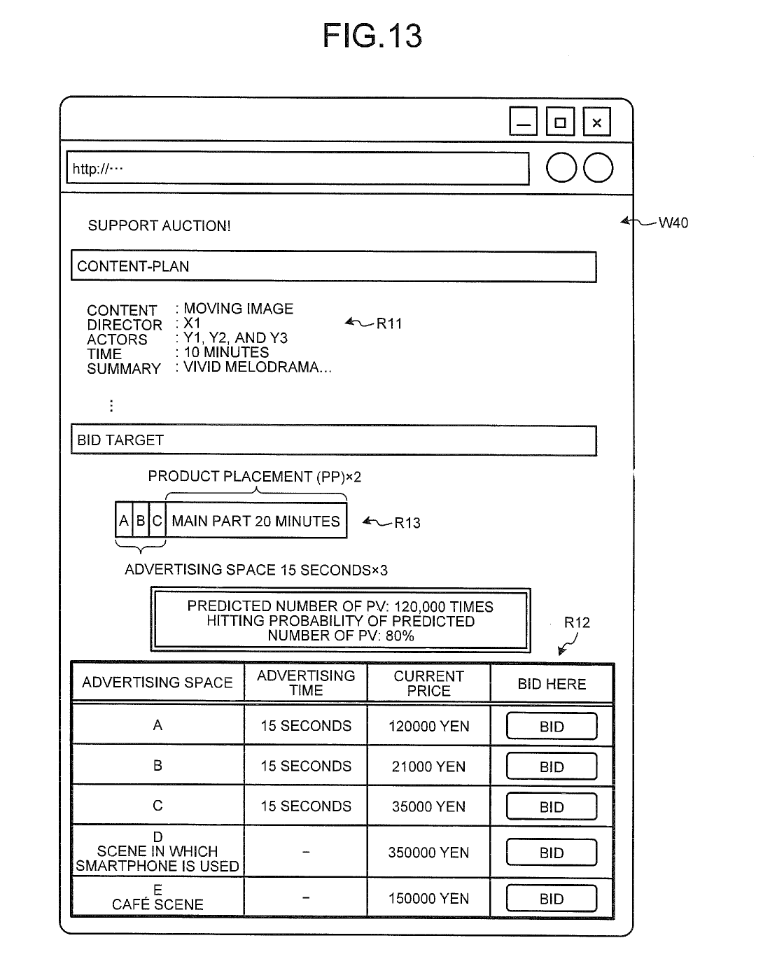

In this case, the service providing unit 132 generates an auction page on which the prediction accuracy is posted. FIG. 13 illustrates an example of an auction page W40 generated by the service providing unit 132 according to the modified example. As illustrated in FIG. 13, the service providing unit 132 posts the predicted number of PV and the prediction accuracy calculated by the calculating unit 141 on the bidding display field R12 of the auction page W40. FIG. 13 illustrates an example in which the predicted number of PV is 120,000, and the prediction accuracy of the predicted number of PV is 80%.

Note that the calculating unit 141 may calculate an achievement probability of reaching the number of PV for each predetermined number of PV using the calculated predicted number of PV and the error number of PV acquired from the prediction history information. For example, the calculating unit 141 uses a prediction accuracy corresponding to the calculated predicted number of PV as a reference achievement probability. Then, the calculating unit 141 obtains, for each predicted number of PV obtained by adding or subtracting a predetermined number to or from the calculated predicted number of PV, an achievement probability that deviates from the reference achievement probability as the addition value or the subtraction value increases. In this case, the service providing unit 132 may generate an auction page on which the achievement probability of each predicted number of PV is posted. At this time, the service providing unit 132 may post a graph representing a relation between the predicted number of PV and the achievement probability on the auction page. For example, the calculating unit 141 is assumed to have calculated “120,000” as the predicted number of PV for content being planned and have calculated “80%” as the prediction accuracy (that is, the reference achievement probability) of the predicted number of PV “120,000”. Then, the calculating unit 141 is assumed to calculate the achievement probability of the predicted number of PV “100,000” obtained by subtracting “20,000” from the predicted number of PV “120,000”. In this case, the calculating unit 141 calculates “0.83=(100,000/120,000)” that is a ratio of “100,000” to “120,000”, and calculates the achievement probability “66.6%” of the predicted number of PV “100,000” by multiplying the ratio “0.83” by the reference achievement probability “80%”. Similarly, the calculating unit 141 calculates achievement probabilities corresponding to predicted number of PVs “60,000”, “80,000”, “140,000”, “160,000”, and “180,000”. Then, the service providing unit 132 posts the achievement probability for each predicted number of PV calculated by the calculating unit 141 on an auction page.

As described above, since the service providing apparatus 100 posts the prediction accuracy of the predicted number of PV on an auction page and thus can visualize a risk in bidding even when an auction is held at the stage of planning content, the service providing apparatus 100 can provide a service having a high value-added to the advertiser.

5-8. Prediction Accuracy and PV Guarantee

Furthermore, in the case of guaranteeing the number of PV as in the examples of FIGS. 11 and 12, the service providing apparatus 100 may decide whether or not the number of PV is to be guaranteed based on the prediction accuracy. For example, only when the prediction accuracy is a predetermined accuracy threshold value or more, the service providing unit 132 may provide a PV guarantee service of guaranteeing the number of PV. As a result, the service providing apparatus 100 can present the number of PV having a high probability of being guaranteed to the advertiser, and thus can provide a service having an value-added to the advertiser.

Here, as in the above examples of FIGS. 9 and 10, when the service providing apparatus 100 periodically updates the predicted number of PV, the prediction accuracy becomes in some cases the accuracy threshold value or more while an auction is being held. At this time, even when the prediction accuracy becomes the accuracy threshold value or more while an auction is being held, the service providing unit 132 does not start provision of the PV guarantee service in the middle of the auction period. This is because if the PV guarantee service is provided in the middle of the auction period, it becomes unfair to the advertiser that has bidden with a risk before the start of provision of the PV guarantee service. However, even when the prediction accuracy becomes the accuracy threshold value or more while an auction is being held, if an auction has not been completed to be held again, the service providing unit 132 may provide the PV guarantee service from the beginning in the auction that is held again.

5-9. Prediction Process after Delivery

Furthermore, the service providing apparatus 100 described above may calculate various kinds of above-described predicted number of PVs (for example, a monthly predicted number of PV or the like) even after composite content has been delivered to the user by the distribution server 30. Then, the service providing apparatus 100 may notify an advertiser having advertisement data incorporated into composite content of a predicted number of PV calculated after composite content is delivered. As a result, the service providing apparatus 100 can provide a service having an value-added to the advertiser even after the composite content has been delivered.

Note that the calculating unit 141 can use a prediction element other than the above-described prediction elements when calculating the predicted number of PV after composite content is delivered. For example, the calculating unit 141 may calculate the predicted number of PV from the “actual number of PV of the previous day” or an “average value of the actual number of PV until the previous day”.

5-10. Service Fee

Furthermore, the service providing apparatus 100 may presents the predicted number of PV to the advertiser as an optional service. For example, the service providing unit 132 may provide an auction page on which the predicted number of PV is posted only to an advertiser that has paid a predetermined service fee.

5-11. Type of Content

Furthermore, in the above embodiments, a moving image has been mainly described as an example of content. However, a type of content is not limited to a moving image. For example, the above-described content may be an application such as a game, a digital book, or a web page such as a weblog. For example, a content creator can use the above-described auction service when planning to create a game, a digital book, or a specialized web page.

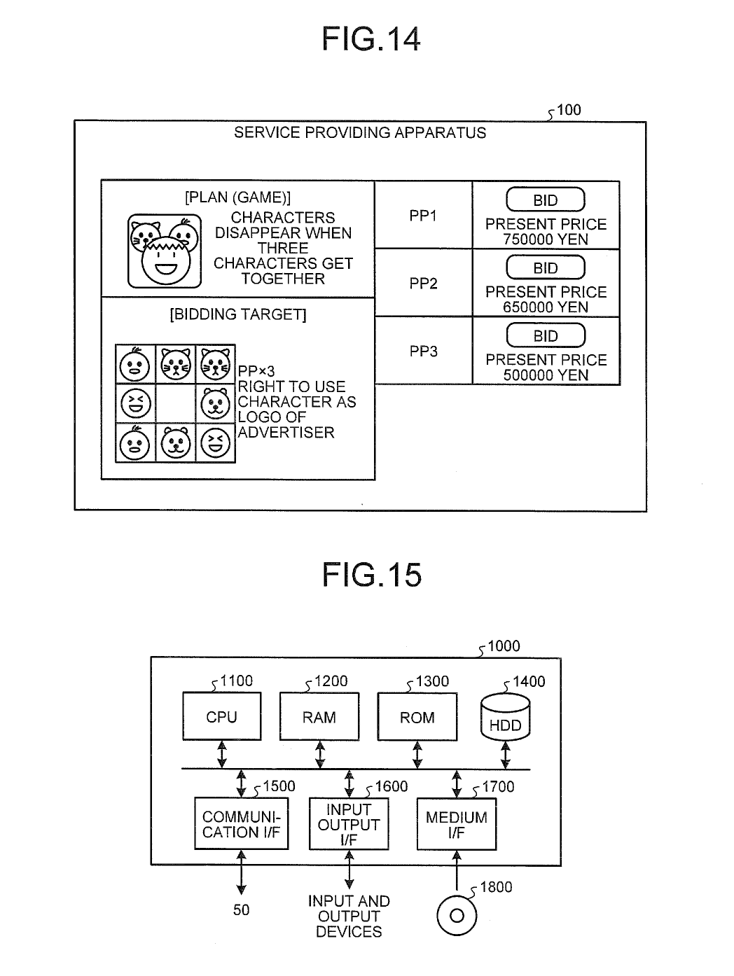

Here, FIG. 14 illustrates exemplary content according to the modified example. FIG. 14 illustrates an example in which content is a game. In the example of FIG. 14, the content creator plans to create a game using icons of characters. Then, the content creator sets three icons among a plurality of types of icons as an advertising space. As described above, the above-described auction service can also be applied to content such as a game.

Note that in the case of the example of FIG. 14, similarly to product placement, the content creator receives an icon image for advertisement and the like from an advertiser that is a winning bidder, and creates a game using the received icon image and the like. Thus, the content creator can create composite content (a game in this example) including advertisement data.

5-12. Program

Furthermore, the service providing apparatus 100 according to the above embodiment is implemented, for example, by a computer 1000 having a configuration illustrated in FIG. 15. FIG. 15 is a hardware block diagram illustrating an exemplary of a computer 1000 to realize the function of the service providing apparatus 100. The computer 1000 includes a CPU 1100, a RAM 1200, a ROM 1300, a HDD 1400, a communication interface (I/F) 1500, an input output interface (I/F) 1600, and a medium interface (I/F) 1700.

The CPU 1100 operates based on a program stored in the ROM 1300 or the HDD 1400, and controls each unit. The ROM 1300 stores, for example, a boot program executed by the CPU 1100 when the computer 1000 is activated, or a program depending on hardware of the computer 1000.

The HDD 1400 stores, for example, a program executed by the CPU 1100 and data used by the program. The communication interface 1500 receives data from other device via a communication network 50, sends the data to the CPU 1100, and transmits data generated by the CPU 1100 to other device via the communication network 50.

The CPU 1100 controls an output device such as a display and a printer and an input device such as a keyboard and a mouse through the input output interface 1600. The CPU 1100 acquires data from the input device through the input output interface 1600. The CPU 1100 outputs generated data to the output device through the input output interface 1600.

The medium interface 1700 reads a program or data stored in a recording medium 1800, and provides the read program or data to the CPU 1100 through the RAM 1200. The CPU 1100 loads the program onto the RAM 1200 from the recording medium 1800 through the medium interface 1700, and executes the loaded program. Examples of the recording medium 1800 include an optical recording medium such as a digital versatile disc (DVD) and a phase change rewritable disk (PD), a magneto optical recording medium such as a magneto-optical disk (MO), a tape medium, a magnetic recording medium, and a semiconductor memory.

For example, when the computer 1000 functions as the service providing apparatus 100 according to the embodiment, the CPU 1100 of the computer 1000 executes the program loaded onto the RAM 1200, and thus implements the function of the control unit 130. Furthermore, data in the auction storage unit 121 or the history information storage unit 122 is stored in the HDD 1400. The CPU 1100 of the computer 1000 reads the program from the recording medium 1800 and then executes the program, but as other example, the program may be acquired from other device via the communication network 50.

5-13. Others

Among the processes described in the above embodiment, some or all of the processes described as being automatically performed can also be manually performed, or some or all of the processes described as being manually performed can also be automatically performed by a known method. In addition, a process, a specific name, or information including various kinds of data or parameters described hereinabove or illustrated in the drawings can be arbitrarily changed unless set forth otherwise herein.

For example, various kinds of information illustrated in the figures are not limited to the illustrated information. Furthermore, for example, the above embodiments have described the example in which a plurality of advertising spaces are set to identical content, but a single advertising space may be set to identical content.

Furthermore, the above embodiments have described the example in which the content creator sets a reproduction position of an advertising space, a reproduction time, or the like in content. However, the service providing apparatus 100 may receive only the plan information from the content creator and may not receive the advertising space information. In this case, for example, the service providing apparatus 100 sets an advertising space of a predefined reproduction position or reproduction time in content.

Furthermore, the above embodiments have described the example in which the service providing apparatus 100 generates composite content, but the process of generating composite content may be performed by other device such as the distribution server 30. In this case, the service providing apparatus 100 illustrated in FIG. 3 may not include the generating unit 135 and the like.

Furthermore, for example, the above embodiments have described the example in which composite content including advertisement data incorporated into content is delivered to the user terminal 40, but the advertisement data may be delivered to the user terminal 40 through an advertising server (not illustrated in FIG. 2) (called an ad server or the like) each time content is displayed or played back by the user terminal 40. Specifically, the generating unit 135 of the service providing apparatus 100 may generate the composite content by incorporating access information (for example, a uniform resource locator (URL)) to the advertising server into an advertising space of content. In this case, the user terminal 40 accesses the advertising server based on the access information set to the advertising space. Then, when there is access from the user terminal 40, the advertising server delivers the advertisement data incorporated into the content to the user terminal 40. At this time, the advertising server selects advertisement data to be delivered based on, for example, a user attribute of an access source user. Then, the user terminal 40 causes the advertisement data acquired from the advertising server to be displayed on the advertising space of content. Furthermore, in the case of this example, the advertiser may transmit access information for accessing, for example, a moving image or a still image that is an advertisement to the service providing apparatus 100, as the advertisement data.

Furthermore, each component of each device illustrated in the drawings is conceptual one, and needs not be necessarily physically configured as illustrated in the drawings. That is, a specific mode of distribution or integration of each device is not limited to the illustrated one, and some or all thereof can be configured to be functionally or physically distributed or integrated by any unit according to various kinds of loads or usage. For example, the plan receiving unit 131 and the content receiving unit 134 illustrated in FIG. 3 may be integrated with each other. Furthermore, for example, the above-described service providing apparatus 100 may be integrated with the distribution server 30.

Furthermore, the above embodiments can be appropriately combined within a range in which processing content is not contradictory.

### 6. Effects

As described above, the service providing apparatus 100 according to the embodiment includes the plan receiving unit 131, the calculating unit 141, and the service providing unit 132. The plan receiving unit 131 receives plan information indicating content-plan of content planned by a content creator. The calculating unit 141 calculates the predicted number of PV (corresponding to an example of the number of predicted viewing) that is a predicted value of the number of times at which content is viewed by a user. The service providing unit 132 presents the predicted number of PV calculated by the calculating unit 141 and the plan information received by the plan receiving unit 131, and provides an auction service in which a right to display an advertisement on the content is a bid target.

As a result, even when an auction is held at the stage of planning content, the service providing apparatus 100 according to the embodiment enables the advertiser that is a bidder to apprehend a predicted number of times at which an advertisement will be viewed by the user. As a result, the service providing apparatus 100 can provide a service having an value-added to the advertiser.

Furthermore, in the service providing apparatus 100 according to the embodiment, when the plan information is received by the plan receiving unit 131, the calculating unit 141 calculates the predicted number of PV based on the views of content having created previously by the content creator.

As a result, the service providing apparatus 100 according to the embodiment can calculate the predicted number of PV from a previous record with a high degree of accuracy and thus can provide a service having a high value-added to the advertiser.

Furthermore, in the service providing apparatus 100 according to the embodiment, when the plan information is received by the plan receiving unit 131, the calculating unit 141 calculates the predicted number of PV based on the views of created content corresponding to the plan information among created content that is content having created previously.

As a result, the service providing apparatus 100 according to the embodiment can calculate the predicted number of PV from a previous record with a high degree of accuracy and thus can provide a service having a high value-added to the advertiser.

Furthermore, in the service providing apparatus 100 according to the embodiment, the plan receiving unit 131 receives the plan information more than once in a stepwise manner. Furthermore, the calculating unit 141 newly calculates the predicted number of PV based on the views of the created content corresponding to new plan information each time the new plan information is received by the plan receiving unit 131. Furthermore, the service providing unit 132 presents the predicted number of PV newly calculated by the calculating unit 141, and provides the auction service.

As a result, when the plan information is received in a stepwise manner, the service providing apparatus 100 according to the embodiment can calculate the predicted number of PV with a high degree of accuracy using the latest plan information, and thus can provide a service having a high value-added to the advertiser.

Furthermore, in the service providing apparatus 100 according to the embodiment, the calculating unit 141 calculates the predicted number of PV based on the views of created content corresponding to auction information including the number of bids or the highest bidding price in the auction service among created content that is content having created previously while the auction service is being provided by the service providing unit 132.

As a result, the service providing apparatus 100 according to the embodiment can calculate the predicted number of PV with a high degree of accuracy using the latest auction information and thus can provide a service having a high value-added to the advertiser.

Furthermore, in the service providing apparatus 100 according to the embodiment, the service providing unit 132 provides the auction service of guaranteeing a winning bidder a predetermined views in the content corresponding to the plan information based on the predicted number of PV calculated by the calculating unit 141.

As a result, the service providing apparatus 100 according to the embodiment can make the advertiser feel at ease about bidding, and thus can provide a service having a high value-added to the advertiser.

Furthermore, the service providing apparatus 100 according to the embodiment includes the winning bid amount managing unit 133 that calculates a refund amount to be refunded to the winning bidder according to a difference between the guaranteed number of PV and the actual number of PV when the actual number of PV of the content corresponding to the plan information does not reach the guaranteed number of PV that is guaranteed by the service providing unit 132.

As a result, the service providing apparatus 100 according to the embodiment can make the advertiser feel at ease about bidding, and thus can provide a service having a high value-added to the advertiser.

Furthermore, in the service providing apparatus 100 according to the embodiment, the calculating unit 141 calculates prediction accuracy of the predicted number of PV calculated for the content corresponding to the plan information based on the predicted number of PV having calculated previously for created content that is content having created previously and the actual number of PV of the created content. Furthermore, the service providing unit 132 presents the predicted number of PV and the prediction accuracy calculated by the calculating unit 141, and provides the auction service.

As a result, the service providing apparatus 100 according to the embodiment can visualize a risk in bidding at the planning stage and thus can provide a service having a high value-added to the advertiser.

Furthermore, in the service providing apparatus 100 according to the embodiment, when the prediction accuracy calculated by the calculating unit 141 is a predetermined accuracy threshold value or more, the service providing unit 132 provides the auction service of guaranteeing the predetermined views in the content corresponding to the plan information based on the predicted number of PV calculated by the calculating unit 141.

As a result, the service providing apparatus 100 according to the embodiment can present the number of PV having a high probability of being capable of being guaranteed to the advertiser and thus can provide a service having a high value-added to the advertiser.

Furthermore, in the service providing apparatus 100 according to the embodiment, the calculating unit 141 calculates the predicted number of PV for each predetermined period of time. Furthermore, the service providing unit 132 presents the predicted number of PV for each predetermined period of time calculated by the calculating unit 141, and provides the auction service.

As a result, the service providing apparatus 100 according to the embodiment can provide the transition of the predicted number of PV to the advertiser and thus can provide a service having a high value-added to the advertiser.

As above, some of the embodiments of the present disclosure have been described above in detail based on the drawings, but the above embodiments are exemplary, and the present invention can be carried out in other modes in which various kinds of modification or improvement are made based on knowledge of a person skilled in the art, including the aspects described in the disclosure of the invention.

Furthermore, “section, module, or unit” described above can be interpreted as “means”, “circuit”, or the like. For example, the plan receiving unit can be interpreted as plan receiving means or a plan receiving circuit.

According to one aspect of an embodiment, such an effect is obtained that a service having an value-added can be provided to an advertiser.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A service providing apparatus, comprising:
a plan receiving unit configured to receive plan information indicating a plan of content planned by a content creator;
a calculating unit configured to calculate the number of predicted views that is a predicted value of the number of times at which the content is viewed by a user; and
a providing unit configured to present the number of predicted views calculated by the calculating unit and the plan information received by the plan receiving unit, and provide an auction service in which a bid target is a right to display an advertisement on the content.

2. The service providing apparatus according to claim 1,
wherein the calculating unit calculates the number of predicted views based on the number of views of content created in the past by the content creator when the plan information is received by the plan receiving unit.

3. The service providing apparatus according to claim 1,
wherein the calculating unit calculates the number of predicted views based on the number of views of created content corresponding to the plan information among created content that is content having created previously when the plan information is received by the plan receiving unit.

4. The service providing apparatus according to claim 3,
wherein the plan receiving unit receives the plan information more than once in a stepwise manner,
the calculating unit newly calculates the number of predicted views based on the number of views of the created content corresponding to new plan information each time the new plan information is received by the plan receiving unit, and
the providing unit presents the number of predicted views newly calculated by the calculating unit, and provides the auction service.

5. The service providing apparatus according to claim 1,
wherein the calculating unit calculates the number of predicted views based on the number of views of created content corresponding to auction information including the number of bids or a highest bidding price in the auction service among created content that is content having created in the past while the auction service is provided by the providing unit.

6. The service providing apparatus according to claim 1,
wherein the providing unit provides the auction service of guaranteeing a winning bidder a predetermined number of views in the content corresponding to the plan information based on the number of predicted views calculated by the calculating unit.

7. The service providing apparatus according to claim 6, further comprising,
a winning bid amount managing unit configured to calculate a refund amount to be refunded to the winning bidder according to a difference between the predetermined number of views and an actual number of views when the actual number of views of the content corresponding to the plan information does not reach the predetermined number of views that is guaranteed by the providing unit.

8. The service providing apparatus according to claim 7,
wherein the winning bid amount managing unit calculates an additional billing amount that is additionally billed to the winning bidder according to the difference between the actual number of views and the predetermined number of views when the actual number of views of the content corresponding to the plan information exceeds the predetermined number of views guaranteed by the providing unit.

9. The service providing apparatus according to claim 1,
wherein the calculating unit calculates prediction accuracy of the number of predicted views calculated for the content corresponding to the plan information based on the number of predicted views calculated previously for created content that is content created in the past and an actual number of views of the created content, and
the providing unit presents the number of predicted views and the prediction accuracy calculated by the calculating unit, and provides the auction service.

10. The service providing apparatus according to claim 9,
wherein the providing unit provides the auction service of guaranteeing the predetermined number of views in the content corresponding to the plan information based on the number of predicted views calculated by the calculating unit when the prediction accuracy calculated by the calculating unit is a predetermined accuracy threshold value or more.

11. The service providing apparatus according to claim 1,
wherein the calculating unit calculates the number of predicted views for each predetermined period of time, and
the providing unit presents the number of predicted views for each predetermined period of time calculated by the calculating unit, and provides the auction service.

12. A service providing method executed by a computer, comprising:
receiving plan information indicating a plan of content planned by a content creator;
calculating the number of predicted views that is a predicted value of the number of times at which the content is viewed by a user; and
presenting the number of predicted views calculated at the calculating and the plan information received at the receiving, and providing an auction service in which a bid target is a right to display an advertisement on the content.

13. A non-transitory computer-readable storage medium with an executable program stored thereon, wherein the program instructs a computer to perform:
receiving plan information indicating a plan of content planned by a content creator;
calculating the number of predicted views that is a predicted value of the number of times at which the content is viewed by a user; and
presenting the number of predicted views calculated at the calculating and the plan information received at the receiving, and providing an auction service in which a bid target is a right to display an advertisement on the content.
